(19) United States
(12) Patent Application Publication
(10) Pub. No.: US 2014/0193920 A1
(43) Pub. Date: Jul. 10, 2014

(54) METABOLOMICS OF HUMAN BIOLOGICAL FLUIDS IDENTIFY SIGNATURES OF MALIGNANT GLIOMA

(71) Applicant: Beth Israel Deaconess Medical Center, Inc., Boston, MA (US)

(72) Inventors: Eric T. Wong, Milton, MA (US); John M. Asara, Winchester, MA (US)

(21) Appl. No.: 14/150,087

(22) Filed: Jan. 8, 2014

Related U.S. Application Data
(60) Provisional application No. 61/750,911, filed on Jan. 10, 2013.

(51) Int. Cl. G01N 27/62

(52) U.S. Cl. CPC G01N 27/62
USPC 436/64

(57) ABSTRACT

A method of identifying a patient in need of therapy to treat a malignant glioma comprising measuring a panel of polar metabolite levels in a biological sample taken from the patient and implementing a therapy to treat the malignant glioma in the patient.

### RELATED APPLICATION

This application claims the benefit of U.S. Provisional Application No. 61/750,911, filed on Jan. 10, 2013. The entire teachings of the above application is incorporated herein by reference.

### GOVERNMENT SUPPORT

This invention was made with government support under P01 CA120964 from National Institutes of Health. The government has certain rights in the invention.

### BACKGROUND OF THE INVENTION

Patients with malignant gliomas (MG) have poor prognosis. Those with glioblastomas have a median survival of 14.6 months and 5-year survival is only 9.8% despite aggressive treatment with temozolomide chemo-irradiation (Stupp, R., et al., Lancet Oncol. 10, 459-466 (2009)). Patients with anaplastic gliomas have a slightly better prognosis with a median survival of 3 to 10 years depending on the molecular genetics of the tumor (Cairncross, G., et al., J. Clin. Oncol. 24, 2707-2714 (2006); Louis, D. N., et al., Am. J. Pathol. 159, 779-786 (2001)). Therefore, having a means of determining the biological state of the malignant glioma would guide the application of proper treatment. Despite the high resolution of magnetic resonance imaging (MRI), only macroscopic structural information is obtained and this measurement does not reveal the underlying biology of the malignant glioma. Although tumor tissue analysis performed serially over time is possible, brain biopsies have inherent sampling errors because of the heterogeneous nature of the tumor and resections may lead to neurological deficits (Chandrasoma, P. T., et al., Neurosurgery 24, 160-165 (1989); Glantz, M. J., et al., Neurology 41, 1741-1744 1991)). Due to these limitations there is a need for an improved and/or complementary method of evaluating malignant gliomas.

### SUMMARY OF THE INVENTION

In one embodiment, the present invention is directed toward a method of identifying a patient in need of therapy to treat a malignant glioma comprising (a) measuring a panel of polar metabolite levels in a biological sample taken from the patient, wherein the polar metabolites are measured using a liquid chromatography/tandem mass spectrometry based platform; (b) determining the levels of two or more polar metabolites present in the patient sample, wherein the polar metabolites comprise the polar metabolites in Supplemental Table S1; (c) comparing the levels of the polar metabolites present in the sample to control levels, wherein a difference in the levels of two or more polar metabolites present in the sample relative to the control levels is indicative of the patient having a malignant glioma; and (d) implementing a therapy to treat the malignant glioma in the patient.

In another embodiment, the present invention is directed toward a method of identifying a patient in need of therapy to treat a recurrent malignant glioma comprising (a) measuring a panel of polar metabolite levels in a biological sample taken from the patient, wherein the polar metabolites are measured using a liquid chromatography/tandem mass spectrometry based platform; (b) determining the levels of two or more polar metabolites present in the patient sample, wherein the polar metabolites comprise the polar metabolites in Supplemental Table S1, (c) comparing the levels of the polar metabolites present in the sample to control levels, wherein a difference in the levels of the two or more polar metabolites present in the sample relative to the control levels is indicative of the patient having a recurrent malignant glioma; and (d) implementing a therapy to treat the recurrent malignant glioma in the patient.

In a further embodiment, the present invention is directed toward a method of monitoring a patient's response to treatment of a malignant glioma comprising (a) measuring a panel of polar metabolite levels in a biological sample taken from the patient, wherein the polar metabolites are measured using a liquid chromatography/tandem mass spectrometry based platform; (b) determining the levels of two or more polar metabolites present in the patient sample, wherein the polar metabolites comprise the polar metabolites in Supplemental Table S1; (c) comparing the levels of the metabolites present in the sample to control levels, wherein a difference in the levels of the two ore more polar metabolites present in the sample relative to the control levels is indicative of the patient not responding to the treatment of the malignant glioma; and (d) implementing a therapy to treat the malignant glioma in the patient.

In one embodiment, the control levels comprise the levels of the metabolites present in a sample from a healthy subject without a malignant glioma.

In another embodiment, increased levels of the metabolites present in the sample relative to the control levels is indicative of the patient having a malignant glioma. In a further embodiment, the same levels of the metabolites present in the sample relative to the control level is indicative of the patient not having a malignant glioma. In yet another embodiment, reduced levels of the metabolites present in the sample relative to the control levels is indicative of the patient having a malignant glioma.

In another embodiment, increased levels of the metabolites present in the sample relative to the control levels is indicative of the patient not responding to the treatment of the malignant glioma. In a further embodiment, the same levels of the metabolites present in the sample relative to the control level is indicative of the patient responding to the treatment of the malignant glioma. In yet another embodiment, reduced levels of the metabolites present in the sample relative to the control levels is indicative of the patient not responding to the treatment of the malignant glioma.

In one embodiment, the two or more metabolites comprise: biotin, glucono-d-lactone, dihydroorotate, orotate, 2,3-dihydroxybenzoic acid, Indole-3-carboxylic acid, Acetylcarnitine DL, Aminoadipic acid, proline, Phenyllactic acid, dTMP, oxaloacetate, Atrolactic acid, methionine, taurine, 2-ketohaxanoic acid, lysine, thiamine, S-methyl-5-thioadenosine, serine, 7-methylguanosine, glutamine, 2-hydroxy-2-methylbutanedioic acid, Phenylpropiolic acid, dTMP, N6-Acetyl-L-lysine, Acetyllysine, N-acetyl-glutamine, purine, ribose-phosphate, myo-inositol, glucosamine, adenine, nicotinamide, phenylalanine, glucose-1-phosphate, hypoxanthine and shikimate.

In a particular embodiment, the two or more metabolites comprise: indole, indoleacrylic acid, histidine and anthranilate.

In one embodiment, the biological sample is selected from cerebrospinal fluid, blood, serum, plasma, urine, tissue from a biopsy, and tissue from a resection.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIGS. 1A-E show data collection and analysis. FIG. 1A shows a histogram of the log-intensities of polar metabolites measured by targeted LC-MS/MS across 17 samples. FIG. 1B shows a histogram of coefficient of variation (CV) of measured metabolites across 17 samples. FIG. 1C shows a scatterplot of average metabolite intensities of control samples (x axis) against malignant glioma (MG) samples. One hundred and eighteen metabolites lie above the line and 71 below the line showing a statistically significant difference. FIG. 1D shows a comparison of a histogram with densities of the log-intensities of measured metabolites of MG samples (blue) and control samples (gray). Each histogram was scaled by dividing values by the total count for each to account for differences in number of data points. Kullback-Leibler (K-L) divergence between the distributions was measured to be 0.0017. FIG. 1E shows comparison of histogram density of the CV (standard deviation/mean) of measured metabolites of MG samples (blue) and control samples (gray). K-L divergence between the distributions was observed to be 0.29.

FIGS. 2A-C show hierarchical clustering of CSF metabolite composition. FIG. 2A shows unsupervised hierarchical clustering of CSF metabolite profiles. FIG. 2B shows Dendrogam obtained from unsupervised hierarchical clustering of CSF metabolite profiles for malignant glioma (MG) and control (Ctrl) samples. The height of the dendrogram represents Euclidean distance. Boxes are drawn around the three clusters. FIG. 2C shows profiles of three signatures that distinguish MG from control samples.

FIGS. 3A-D show principal component analysis (PCA) of CSF metabolite composition. FIG. 3A shows fraction of variance explained (Fraction variance) plotted across principal component number. Black bars indicate values obtained from measured data. Green bars indicate average values obtained from a PCA analysis of n=100,000 random, normally distributed data of dimension, mean, and variance equivalent to the measured data. Numerical values of the first three components are shown in the caption for each case. *denotes p=8.3e-15, ** denotes p=2.6e-5, *** denotes p=1.8e-9. p values were obtained from Monte Carlo simulations. FIG. 3B shows loadings plot obtained from the PCA analysis. Coefficients of eigenvectors for the first and second principal components are shown. FIG. 3C shows Kegg pathway analysis of the first three significant principal components. The first column lists the pathway and the second column lists the number of metabolites identified within the pathway for the top 40 coefficients in magnitude for each principal component. Abbreviations: Phe, Phenylalanine; Tyr, Tyrosine; Ala, Alanine FIG. 3D shows projection of individual samples onto the first two principal components. Colors correspond to cluster membership as assigned by k-means clustering with k=3. Samples from malignant glioma patients segregate into two groups and the control samples segregate into a separate group. FIG. 3E shows representative MRI images of the tumors from patients in group 1 and group 2.

FIGS. 4A-D show the metabolite signatures of GBM subtypes and correlations with clinical parameters. FIG. 4A shows the number of metabolites that change in the CSF of malignant glioma samples relative to the control patients as a function of p value cutoff using a two-tailed t test statistic. FIG. 4B shows the TCA cycle signature associated with patients 3 and 10 and its relative contribution across patient samples. Signature score is defined as the normalized sum of metabolite intensity of the citric acid cycle components (succinate, fumarate, alpha-ketoglutarate, malate, oxaloacetate, isocitrate, and citrate). FIG. 4C shows the tryptophan metabolism intermediates associated with recurrent disease (p value<0.05). FIG. 4D shows example metabolites cholesteryl-sulfate and myo-inositol that positively and negatively correlate (R²) with tumor size as measured with MRI using Tgad and FLAIR (x axis) and correlated with the integrated total ion current (TIC) peak areas (y axis) obtained from targeted LC-MS/MS measurements.

The foregoing will be apparent from the following more particular description of example embodiments of the invention, as illustrated in the accompanying drawings.

### DETAILED DESCRIPTION OF THE INVENTION

Determining metabolite levels in a patient in need of therapy to treat a malignant glioma offers the advantage of earlier diagnosis of previously undiagnosed malignant gliomas as well as earlier detection of recurrent malignant gliomas. The current method that is used to detect malignant glioma is MRI. However, MRI only offers structural information and no physiological information is routinely available. Further, by the time the tumor is detectable on MRI, the tumor will contain approximately 1 billion cells. The data described herein show that determining metabolite levels in a biological sample offers a method to diagnose the tumor at an earlier timepoint. This is particularly relevant for recurrent disease because recurrent disease is more heterogenous and chaotic genetically. In theory, when treatment is applied to a smaller number of tumor cells, the fewer resistant clones will emerge.

When MRI is used in conjunction with metabolite analysis, the combined approach may allow for an earlier detection of recurrent disease. In addition to MRI, metabolite analysis can be used in conjunction with computed tomography (CT), nuclear medicine scans, for example, positron emission tomography (PET) and single photon emission computed tomography (SPECT) scans. Brain tumor tissue obtained from biopsy or resection can also be combined with metabolite analysis. Furthermore, in certain patients with newly diagnosed brain tumors, metabolite analysis may obviate a brain biopsy, which is the current standard of diagnosis. Biopsy procedures are costly and there is risk of bleeding and infection. Further, sometimes the biopsy result is non-diagnostic because, due to tissue heterogeneity within the tumor, the biopsy needle may be inserted into the less aggressive or relatively normal part of the tumor. Moreover, patients do not want a brain biopsy if they can avoid one. Therefore, having metabolite analysis as a sole means, or as an adjunctive means, of detection is advantageous. Lastly, anti-metabolomic drugs may be useful for a patient in need of therapy to treat a malignant glioma, to be used alone, or in conjunction with standard therapies.

As used herein “malignant glioma”, includes, for example, glioblastoma, anaplastic oligoastrocytoma, anaplastic astrocytoma, anaplastic oligodendroglioma and anaplastic ganglioglioma. In addition, as used herein “malignant glioma” includes transformed malignant gliomas from low-grade gliomas, such as low-grade astrocytoma, low-grade oligodendroglioma, low-grade oligoastrocytoma and low-grade ganglioglioma. Malignant gliomas can be characterized by histology as well as by genetic profiling by methods known in the art.

As used herein, a difference (e.g., an increase or a decrease) in the expression level of a selected metabolite, or panel of selected metabolites, in the sample relative to the corresponding control level is indicative of the patient having a malignant glioma. As used herein, “difference” refers to any statistically significant difference in the level of a selected metabolite, or panel of selected metabolites, in a test sample relative to the level of the same metabolite in a corresponding control sample. Statistical methods for determining significant differences in metabolite levels are described herein and are also well known in the art. As used herein, the “control level” comprises the level of the metabolite present in the sample from a healthy subject without a malignant glioma.

An increased level of the metabolite present in the sample relative to the control level is indicative of the patient having a malignant glioma. The same level of the metabolite present in the sample relative to the control level is indicative of the patient not having a malignant glioma.

When monitoring a patient's response to treatment of a malignant glioma, increased levels of the metabolites present in the sample relative to the control levels is indicative of the patient not responding to the treatment of the malignant glioma. In a further embodiment, the same levels of the metabolites present in the sample relative to the control level is indicative of the patient responding to the treatment of the malignant glioma. In yet another embodiment, reduced levels of the metabolites present in the sample relative to the control levels is indicative of the patient not responding to the treatment of the malignant glioma.

The terms “subject” or “patient” as used herein refers to any subject, particularly a mammalian subject, for whom diagnosis, prognosis, or therapy of a malignant glioma is desired. As used herein, the terms “subject” or “patient” include any human or nonhuman animal. The term “nonhuman animal” includes all vertebrates, e.g., mammals and non-mammals, such as nonhuman primates, sheep, dogs, cats, horses, cows, bears, chickens, amphibians, reptiles, etc. As used herein, phrases such as “patient in need of therapy to treat a malignant glioma” includes subjects, such as mammalian subjects, that would benefit from the administration of a therapy, imaging or other diagnostic procedure for that malignant glioma.

As used herein, the term “healthcare provider” refers to individuals or institutions which directly interact and administer to living subjects, e.g., human patients. Non-limiting examples of healthcare providers include doctors, nurses, technicians, therapist, pharmacists, counselors, alternative medicine practitioners, medical facilities, doctor's offices, hospitals, emergency rooms, clinics, urgent care centers, alternative medicine clinics/facilities, and any other entity providing general and/or specialized treatment, assessment, maintenance, therapy, medication, and/or advice relating to all, or any portion of, a patient's state of health, including but not limited to general medical, specialized medical, surgical, and/or any other type of treatment, assessment, maintenance, therapy, medication and/or advice.

In some aspects, a healthcare provider can administer or instruct another healthcare provider to administer a therapy to treat a malignant glioma. A healthcare provider can implement or instruct another healthcare provider or patient to perform the following actions: obtain a sample, process a sample, submit a sample, receive a sample, transfer a sample, analyze or measure a sample, quantify a sample, provide the results obtained after analyzing/measuring/quantifying a sample, receive the results obtained after analyzing/measuring/quantifying a sample, compare/score the results obtained after analyzing/measuring/quantifying one or more samples, provide the comparison/score from one or more samples, obtain the comparison/score from one or more samples, administer a therapy (e.g., a therapeutic agent that treats a malignant glioma), commence the administration of a therapy, cease the administration of a therapy, continue the administration of a therapy, temporarily interrupt the administration of a therapy, increase the amount of an administered therapeutic agent, decrease the amount of an administered therapeutic agent, continue the administration of an amount of a therapeutic agent, increase the frequency of administration of a therapeutic agent, decrease the frequency of administration of a therapeutic agent, maintain the same dosing frequency on a therapeutic agent, replace a therapy or therapeutic agent by at least another therapy or therapeutic agent, combine a therapy or therapeutic agent with at least another therapy or additional therapeutic agent.

As used herein, the term “therapy” includes any means for eliminating, reducing, preventing or slowing the growth of a malignant glioma, including, for example, therapeutic agents and surgical procedures. In this respect, the term therapy encompasses any protocol, method and/or therapeutic or diagnostic that can be used in eliminating, reducing, preventing or slowing the growth of a malignant glioma. In some aspects, the term “therapy” refers to administering a therapeutically effective amount of a therapeutic agent that is capable of eliminating, reducing, preventing or slowing the growth of a malignant glioma in a patient in need thereof.

As used herein “a panel” of metabolite levels refers to a combination or subcombination of two or more metabolite levels.

As used herein, the term “two or more” in the context of metabolites means any two, three, four, etc. of the listed members within a group, in any permutation. Accordingly, the term “two or more” include any two, any three, any four, etc. of the members specifically listed within a group. Thus, the invention is not limited to any single group or subset of metabolites. It is emphasized that the term “two or more” is used in the broadest sense, and is used to designate any subgroup within a group with multiple members.

Metabolites suitable for use in the methods of the invention include those listed in Supplemental Table S1 and Table 2. Preferred metabolites are listed in Table 2. Any combination of two or more of the metabolites listed in Supplemental Table S1 and Table 2 can be used in the methods of the invention.

As used herein “liquid chromatography/tandem mass spectrometry” or “LC-MS/MS” is employed in the methods of the invention and it refers to a method where a sample mixture is first separated by liquid chromatography before being ionised and characterised by mass-to-charge ratio and relative abundance using two mass spectrometers in series.

As used herein “tandem mass spectrometry,” or “MS/MS” (e.g., using a quadrapole mass spectrometer) refers to a technique wherein a precursor ion or group of ions generated from a molecule (or molecules) of interest may be isolated or selected in an MS instrument, and these precursor ions subsequently fragmented to yield one or more fragment ions that are then analyzed in a second MS procedure. By careful selection of precursor ions, ions produced by certain analytes of interest are selectively passed to the fragmentation chamber, where collision with atoms or molecules of an inert gas occurs to produce the fragment ions. Because both the precursor and fragment ions are produced in a reproducible fashion under a given set of ionization/fragmentation conditions, the MS/MS technique can provide an extremely powerful analytical tool. For example, the combination of filtration/fragmentation can be used to eliminate interfering substances, and can be particularly useful in complex samples, such as biological samples.

In a preferred embodiment, samples are subjected to a liquid chromatography (LC) purification step prior to mass spectrometry. Methods of coupling liquid chromatography techniques to MS analysis are well known and widely practiced in the art. Traditional LC analysis relies on the chemical interactions between sample components and column packings, where laminar flow of the sample through the column is the basis for separation of the analyte of interest from the test sample. The skilled artisan will understand that separation in such columns is a diffusional process.

Numerous column packings are available for chromatographic separation of samples, and selection of an appropriate separation protocol is an empirical process that depends on the sample characteristics, the analyte of interest, the interfering substances present and their characteristics, etc. Various packing chemistries can be used depending on the needs (e.g., structure, polarity, and solubility of compounds being purified).

In various embodiments the columns are polar, ion exchange (both cation and anion), hydrophobic interaction, phenyl, C-2, C-8, C-18 columns, polar coating on porous polymer, or others that are commercially available. During chromatography, the separation of materials is effected by variables such as choice of eluant (also known as a “mobile phase”), choice of gradient elution and the gradient conditions, temperature, etc.

An analyte may be purified by applying a sample to a column under conditions where the analyte of interest is reversibly retained by the column packing material, while one or more other materials are not retained. In these embodiments, a first mobile phase condition can be employed where the analyte of interest is retained by the column, and a second mobile phase condition can subsequently be employed to remove retained material from the column, once the non-retained materials are washed through. Alternatively, an analyte may be purified by applying a sample to a column under mobile phase conditions where the analyte of interest elutes at a differential rate in comparison to one or more other materials. As discussed above, such procedures may enrich the amount of one or more analytes of interest relative to one or more other components of the sample.

One or more LC purification steps can be performed “online” with subsequent MS analysis steps. The term “online” as used herein refers to steps performed without further need for operator intervention. For example, by careful selection of valves and connector plumbing, two or more chromatography columns can be connected such that material is passed from one to the next without the need for additional manual steps. The selection of valves and plumbing is controlled by a computer pre-programmed to perform the necessary steps. Preferably, the chromatography system is also connected in such an in-line fashion to the detector system, e.g., an MS system. Thus, an operator may place a tray of samples in an autosampler, and the remaining operations are performed “on-line” under computer control, resulting in purification and analysis of all samples selected.

As used herein “biological sample” includes, for example, cerebrospinal fluid, blood, serum, plasma, urine and tissue from a biopsy or surgical resection. Samples can be obtained by any means known in the art.

Because the CSF bathes the tissues of the central nervous system (CNS), it provides an attractive source of material for clinical diagnostics. CSF is readily accessible either by lumbar puncture or reservoir sampling, which is less invasive and can be performed serially and may potentially yield a more integrated view of the tumor's activity (Swanson, K., et al., Ann. Neurol. 66, S58 (2009) and Lehtinen, M. K., et al., Neuron 69, 893-905 (2010)). As a result, CSF-derived biomarkers may provide an earlier diagnosis than MRI, obviate invasive procedures, offer information on the tumor's biological state, prognosticate patient survival, and/or predict treatment responses.

CSF derived from patients presenting malignant gliomas may contain signatures of altered metabolism known to occur in tumor cells and may further harbor signatures of secondary, noncell-autonomous effects that arise from the tumor microenvironment (Locasale, J. W., et al., Nat. Biotechnol. 27, 916-917 (2009); Luo, J., et al., Cell 136, 823-837 (2009); Vander Heiden, M. G., et al., Science 324, 1029-1033 (2009); and Michelakis E D, et al., Sci. Translation Med. 2, 31-34 (2010)). Such physiological processes include inflammation, endocrine pathophysiology, and cellular debris resulting from necrotic cells that accumulates as a byproduct of disrupted tissue architecture (Tlsty, T. D., and Coussens, L. M., Annu. Rev. Pathol.-Mech. Dis. 1, 119-150 (2006)).

Metabolic profiling is useful as a diagnostic tool in the setting of human cancer. Studies of metabolites from patient urine that were discovered using metabolomics technology have recently come into focus as possible biomarkers for metastatic prostate cancer and renal cell carcinoma (Sreekumar, A., et al., Nature 457, 910-914 (2009) and Lin, L., et al., J. Proteome Res. 10, 1396-1405 (2011)). For example, one study used mass spectrometry to probe the metabolic composition of urine in patients with prostate cancer at different stages of the disease. The study identified a collection of metabolites that correlated with advanced metastatic prostate cancer including glycine and N-methylglycine (sarcosine) (Sreekumar, A., et al., Nature 457, 910-914 (2009)).

There is extensive evidence of altered cellular metabolism during tumorigenesis. In particular there is increasing evidence that many of the recurrent genetic alterations that contribute to the pathogenesis of gliomas induce changes in cellular metabolism (Parsons, D. W., et al., Science 321, 1807-1812 (2008)). Recurrent genetic events in glioma such as MYC amplification, PTEN deletion or protein loss and EFGR amplification have multiple downstream metabolic targets (Deberardinis, R. J., et al., Cell Metab 7, 11-20 (2008)). Also the metabolic genes IDH1 and IDH2 are mutated in ˜12% of primary gliomas through a gain-of-function mutation that alters the enzymatic activity of the protein product that results in the production of 2-hydroxyglutarate (Dang, L., et al., Nature 462, 739-744 (2009)).

Recent metabolic profiling of CSF has revealed a rich composition of diverse metabolites present in high concentrations in normal patient CSF (Wuolikainen, A., et al., PLoS One 6, e17947; Rosenling, T., J. Proteome Res. 8, 5511-5522 (2009); Wishart, D. S., et al., J. Chromatogr. B 871, 164-173 (2008); Crews, B., et al., Anal. Chem. 81, 8538-8544 (2009); Stoop, M. P., Mol. Cell. Proteomics 9, 2063-2075 (2010); and Rosenling, T., et al., Clin. Chem. 57, 1703-1711)). Further clinical studies have found alterations in the composition of CSF under pathological conditions. One study identified gross alterations in metabolic profiles in patients diagnosed with schizophrenia (Holmes, E., et al., PLos Med. 3, 1420 (2006)). Another study showed that macaques infected with simian immunodeficiency virus undergo detectable changes in the composition of their CSF (Wikoff, W. R., et al., J. Clin. Invest. 2661-2669 Page (2008)).

As described in the Example herein, using a liquid chromatography/tandem mass spectrometry (LC-MS/MS) based platform employing selected reaction monitoring (SRM) with positive and negative ion switching using a 5500 QTRAP hybrid dual quadrupole linear ion trap mass spectrometer (Qq-IT), it was investigated whether unique molecular features in the CSF of patients with malignant gliomas using a limited sample set could be identified (Yuan, M., et al., Nature Protocols In press 2012; Kelly, A. D., et al., PLoS One 6, e25357; Locasale, J. et al., Nat. Genet. 43, 869-874; Anastasiou, D., et al., Science 334, 1278-1283; and Yi, C. H., et al., Cell 146, 607-620)). The platform utilizes hydrophilic interaction chromatography (HILIC) at pH=9.0 (Bajad, S. U., J. Chromatogr. A 1125, 76-88 (2006) and Lu, W., et al., J. Chromatogr. B 871, 236-242 (2008)). 254 unique polar metabolites from 285 SRM scans were targeted from a single 16-min experiment without chromatographic scheduling. The platform was designed to include as many polar metabolites that cover major metabolic pathways including glycolysis, TCA cycle, the pentose phosphate pathway, amino acid metabolism, nucleotide metabolism, etc. to study cancer cell metabolism. The relative levels of 124 water-soluble metabolites were robustly quantified using microliter quantities (250 μl) of patient CSF in a cohort of patients with malignant gliomas and a control cohort without any malignancy. Many of these metabolites overlap with those detected in previous CSF metabolomics studies referenced above. Using multiple computational algorithms to classify the data in an unbiased manner, significant differences in the metabolite composition between patients with the disease and controls were identified, as well as those with newly diagnosed and recurrent malignant gliomas. Together, the findings demonstrate that the metabolite composition of a biological fluid, in particular, the CSF, reasonably provides clinically relevant biomarkers and insights into the mechanisms underlying the pathogenesis of malignant gliomas. Further, these findings reasonably provide a basis for clinical studies that can determine the sensitivity and specificity, as well as the predictive value, of the metabolite biomarkers identified in the CSF.

A description of example embodiments of the invention follows.

### Example

### Experimental Procedures

### Patients and CSF

Aliquots of 5-10 ml of CSF were obtained from male and female patients aged 27 through 67 and of varying disease state in the Brain Tumor Clinic at Beth Israel Deaconess Medical Center (BIDMC) by ETW and staff. CSF samples were collected at the time of neurological evaluation when there was an indication for lumbar puncture or sampling from a ventricular reservoir. All samples were collected from lumbar puncture except one (patient 3 in Table I) whose CSF was taken from a ventricular drain. Patient consents were obtained for CSF storage and CSF biomarker analysis under institutional review board (IRB)-approved protocols at BIDMC. Samples were stored at −80° C. until the time of the experiment. Other clinical CSF parameters, such as white blood cell (WBC) count, total protein level, glucose level, LDH level, and cytology were also tabulated. New versus recurrent diagnosis, survival time, tumor size estimated through MRI, and survival status at end of study, age, and gender were also recorded.

### Sample Preparation

Two hundred and fifty microliters of CSF were subjected to overnight precipitation in 80% methanol at −20° C. followed by centrifugation at 13,000 rpm for 10 min at 4° C. Supernatants were collected and dried under vacuum and reconstituted in 50 μl of 95:5 LC/MS grade water/HPLC grade acetonitrile and then cleared by centrifugation at 13,000 rpm for 5 min. Supernatants were then dried to a pellet using a SpeedVac (Thermo Fisher Scientific) and stored at −80° C. for analysis.

### Targeted Mass Spectrometry

Samples were resuspended using 20 μl LC/MS grade water for mass spectrometry. Ten microliters were injected and analyzed using a 5500 QTRAP triple quadrupole mass spectrometer (AB/SCIEX) coupled to a Prominence UFLC HPLC system (Shimadzu) via SRM of a total of 285 SRM transitions using positive and negative polarity switching corresponding to 254 unique endogenous water soluble metabolites. Some metabolites were targeted in both positive and negative ion mode. Electrospray ionization voltage was +4900V in positive ion mode and −4500V in negative ion mode with a source temperature of 475° C. The dwell time was 4 ms per SRM transition and the total duty cycle time for all metabolites was 1.89 s resulting in ˜9-12 data points acquired per detected metabolite. Samples were delivered to the 5500 QTRAP using a 2.0 mm i.d×15 cm Luna NH₂ hydrophilic interaction chromatography (HILIC) column (Phenomenex, Torrance, Calif.) at 300 μl/min. Gradients were run starting from 85% buffer B (HPLC grade acetonitrile) to 40% B from 0-5 min; 40% B to 0% B from 5-16 min; 0% B was held from 16-24 min; 0% B to 85% B from 24-25 min; 85% B was held for 7 min to re-equilibrate the column. Buffer A was comprised of 20 mM ammonium hydroxide/20 mM ammonium acetate (pH=9.0) in 95:5 water/acetonitrile. Peak areas from the total ion current for each metabolite SRM transition were integrated using MultiQuant version 1.1 software (AB/SCIEX) via the MQ4 peak integration algorithm using a minimum of eight data points with a 30 s retention time window.

### Computational Analysis

All calculations were carried out using the R programming suite (http://www.r-project.org/). The resulting integrations from the MultiQuant software provided a starting point for subsequent analyses. All metabolites undetected in at least one sample were excluded from the analysis. This more conservative convention was chosen because it was found to be more robust than considering imputations for undetected metabolites, which can lead to statistical artifacts. This pruning step reduced the number of metabolites to 124. Principal components analysis (PCA) on the peak integrations was carried out using the prcomp( ) method in the R statistical computing language (http://www.r-project.org/). As is standard, data were normalized to the mean and data transformed to standard units. To assess the statistical significance, a Monte Carlo analysis was used. A set of n=100,000 random matrices with normally distributed matrix elements of mean and variance identical to that of the original data was considered. The eigenvalue spectrum of each matrix and a histogram for each principal component was computed. p values were obtained by comparing the eigenvalues for each principal component in the actual data to the histogram obtained from random data. p values were found to be 7.7×10⁻¹⁵, 2.6×10⁻⁵, and 1.8×10⁻⁹ respectively for the three largest components. Pathway analysis using the KEGG (www.genome.jp/kegg/) pathway database was carried out using metaboanalyst (www.metaboanalyst.ca) (Xia, J., and Wishart, D. S. Curr. Protoc. Bioinformatics Chapter 14, Unit 14 10)). The absolute value of the coefficients (loadings) for each component was obtained and then ranked from highest to lowest. The top 40 values were used for the pathway analysis. The overlay of the k-means clustering was carried out using the kmeans( ) method in R. k=3 clusters were obtained starting with three partitions using 20 iterations to ensure convergence. Hierarchical clustering was performed using Ward's method in the hclust( ) method that minimizes the variance in each cluster (Ward, J. H. J. Am. Stat. Assoc. 58, 236 (1963)). All reported R² values were obtained from Pearson correlations. p values were obtained using two-tailed t test statistics except for the principal components analysis for which a one-tailed statistic was used.

### Results

### Study Design and Metabolomics Platform

CSF was collected from patients (Table I) as part of their routine clinical care under an institutionally approved IRB protocol. Among the 10 patients with malignant gliomas, four had newly diagnosed and six had recurrent disease (Table I). There were six glioblastomas, two anaplastic astrocytomas, and two anaplastic oligoastrocytomas (Table I). CSF samples from seven control subjects without any malignancy were also analyzed. All samples were collected from lumbar puncture except one (patient 3 in Table I) whose CSF was taken from a ventricular drain.

In the Qq-IT triple quadrupole system that employs SRM, the first quadrupole isolates a precursor ion and transfers it induced dissociation whereby the third analyzer (linear ion trap) then isolates a selected fragment ion for quantitative analysis. Positive and negative ion switching was possible because of the 50 millisecond (msec) switch time and 4 msec dwell time in the 5500 QTRAP. The entire duty cycle for 285 SRM scans were performed in ˜1.89 s. Approximately nine to 12 data points were collected per peak with ˜8-9 s peak width at half height.

TABLE I
(A) Clinical profile of patients with malignant gliomas and (B) their CSF profiles. GBM,
glioblastoma; AOA, anaplastic oligoastrocytoma; and AA, anaplastic astrocytoma; XRT,
radiation therapy; TMZ, temozolomide; and CPT-11, irinotecan. Newly Diagnosed (N),
Recurrent (R). Δ(Initial-Sample Date) (time from diagnosis to sample collection).
WBC-White Blood Cell Count (number/μl), Protein (mg/dL), Glucose (mg/dL),
LDH (International Units/L). T1 GAD-2D tumor size estimate from Gadolinium MRI.
FLAIR-2D MRI tumor size estimate from FLAIR
A

| | | | | Newly | Δ (Initial- | |
|---|---|---|---|---|---|---|
| | | | | Diagnosed | Sample | |
| | | | | or | Date) | Survival |
| Patient | Age | Gender | DIAGNOSIS | Recurrent | (months) | (months) |
| 1 | 61 | M | GBM | N | 0 | 8 |
| 2 | 59 | M | GBM | N | 0 | 9 |
| 3 | 45 | F | AOA | R | 34 | 34 |
| 4 | 67 | M | GBM | R | 9 | 17 |
| 5 | 57 | M | AOA | N | 0 | 21 |
| 6 | 27 | F | AA | R | 3 | 27 |
| 7 | 55 | M | GBM | N | 0 | 37 |
| 8 | 41 | F | AA | R | 8 | 27 |
| 9 | 52 | M | GBM | R | 7 | 18 |
| 10 | 46 | F | GBM | R | 12 | 14 |

B

| | | | | | | | Δ (FLAIR − | |
|---|---|---|---|---|---|---|---|---|
| | | | | | T1 Gad | FLAIR | T1 Gad) | |
| Patient | WBC | Protein | Glucose | LDH | (cm²) | (cm²) | (cm²) | Treatment |
| 1 | 2 | 23 | 63 | 11 | 1 | 23.8 | 22.8 | |
| 2 | 2 | 47 | 70 | 9 | 5.7 | 37.6 | 31.9 | |
| 3 | 3 | 209 | 87 | N/A | 9 | 39.1 | 30.1 | XRT, |
| | | | | | | | | TMZ, |
| | | | | | | | | Avastin, |
| | | | | | | | | CPT-11 |
| 4 | 1 | 96 | 67 | 56 | 23.9 | 43.6 | 19.7 | XRT, |
| | | | | | | | | TMZ, |
| | | | | | | | | ZD6474, |
| | | | | | | | | NovoTTF |
| 5 | 2 | 63 | 63 | 19 | 0.7 | 11.6 | 10.9 | |
| 6 | 3 | 61 | 93 | N/A | 2.6 | 3.7 | 1.1 | XRT, |
| | | | | | | | | TMZ |
| 7 | 1 | 51 | 73 | 26 | 1.2 | 36.5 | 35.3 | |
| 8 | 5 | 57 | 77 | 22 | 0.6 | 13.2 | 12.6 | XRT, |
| | | | | | | | | TMZ, |
| | | | | | | | | Avastin, |
| | | | | | | | | CPT-11 |
| 9 | 1 | 41 | 63 | N/A | 17.6 | 28.5 | 10.9 | XRT, |
| | | | | | | | | TMZ, |
| | | | | | | | | NovoTTF |
| 10 | 4 | 158 | 76 | 56 | 10.2 | 37.6 | 27.4 | XRT, |
| | | | | | | | | TMZ, |
| | | | | | | | | CPT-11 |

### Metabolomics of Patient-Derived CSF

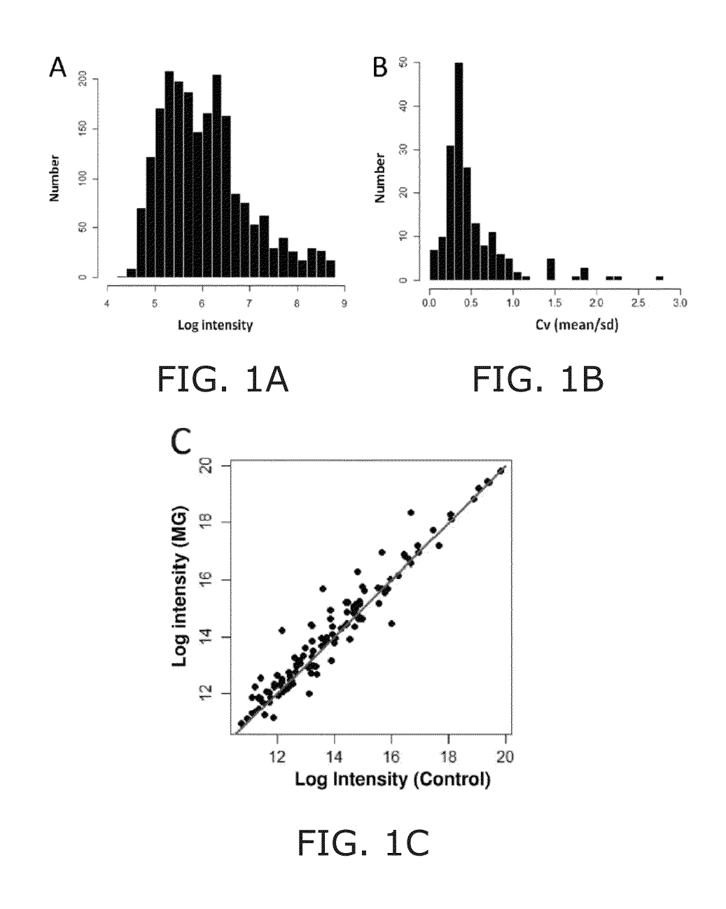

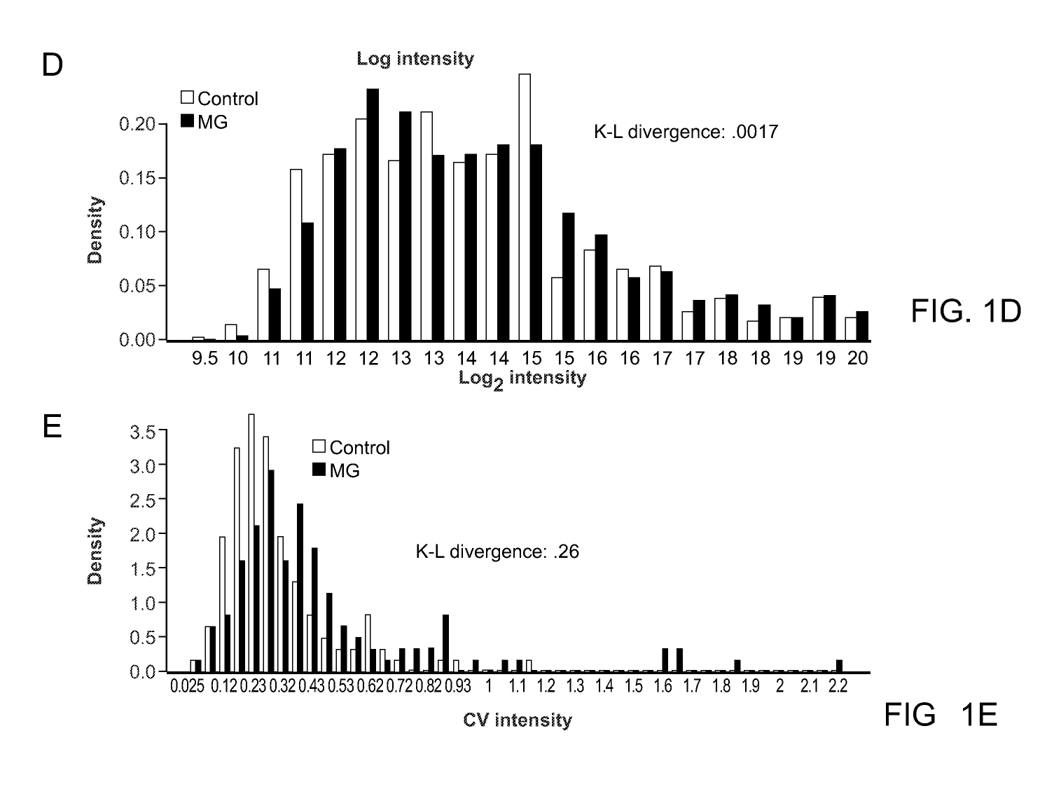

Using the metabolomics platform, over 124 polar metabolites from 17 samples (10 malignant gliomas and seven controls) in total from patient CSF (supplemental Table S1) were robustly (observed recorded peak area intensity across each patient sample having a signal-to-noise >2:1) measured. An analysis of the distribution of intensities of the recorded concentrations showed approximately a log-normal distribution (FIG. 1A). An inspection of the width of the distribution showed a dynamic range of ˜4 orders of magnitude (FIG. 1A). To understand the extent of variation in the data, the coefficient of variation (standard deviation/mean) or CV was computed for each metabolite. An analysis of the histogram revealed that metabolite CV's are concentrated from 0.25-0.75 (FIG. 1B). An analysis of the average intensities of the malignant glioma samples plotted against control samples revealed substantial differences in the average metabolite intensities (FIG. 1C). Eighty-six metabolites were on average higher in the malignant glioma samples and 38 metabolites were higher on average in the control samples. These differences can be better visualized when plotting the histogram of intensities in control samples (blue) and compared with MG samples (gray) (FIG. 1D). From the histograms, it is apparent that gross similarities (Kullback-Leibler (K-L) divergence=0.0017) in the metabolite intensities of malignant gliomas and controls are obtained suggesting that metabolites levels are typically on the same order of magnitude in control versus MG subjects. These differences in intensities could further be observed by analyzing the differences in the coefficient of variation (CV), as expressed by histogram (FIG. 1E), of controls and MG patients. Interestingly, the histograms of the CV exhibited a larger divergence (K-L divergence=0.26) demonstrating that the MG patients showed more variability in their metabolite composition. This finding suggested that better-distinguished subtypes of metabolite composition might be obtained in MG samples than in control samples. These observations also indicate that a diverse set of metabolites can be identified in a small volume (less than or equal to 250 μl) of CSF. Thus, a mass spectrometry based metabolomics analysis of CSF could potentially distinguish malignant glioma patients from those without any malignancy as well as fine structure within the MG population.

SUPPLEMENTAL TABLE S1

| | | | | | | Fold | | Fold | |
|---|---|---|---|---|---|---|---|---|---|
| | | | | | | change | | change | |
| | | | | | Surival | (glioma | | (Recurrent | |
| | | Tgad | Flair | Delta | time | vs. | | vs. | |
| Metabolite | ID | correlation | correlation | correlation | correlation | control) | P-val | New) | P-val |
| anthranilate | C00108 | −0.07 | −0.12 | −0.10 | 0.42 | 1.16 | 0.29 | 0.74 | 0.02 |
| Indoleacrylic acid | C00331 | 0.47 | 0.38 | 0.13 | 0.25 | 1.01 | 0.95 | 0.59 | 0.03 |
| histidine | C00135 | 0.07 | 0.05 | 0.01 | 0.41 | 1.14 | 0.31 | 0.76 | 0.03 |
| cholesteryl sulfate | HMDB00653 | 0.79 | 0.50 | 0.05 | −0.06 | 0.84 | 0.76 | 0.27 | 0.03 |
| indole | C16074 | 0.39 | 0.32 | 0.11 | 0.37 | 1.28 | 0.16 | 0.56 | 0.03 |
| choline | C00114 | 0.37 | 0.37 | 0.19 | 0.13 | 1.04 | 0.82 | 0.62 | 0.04 |
| Urea | C00086 | −0.30 | −0.15 | 0.03 | −0.05 | 1.11 | 0.26 | 1.24 | 0.04 |
| arginine | C00062 | 0.19 | 0.03 | −0.10 | 0.31 | 1.31 | 0.13 | 0.61 | 0.05 |
| tryptophan | C00078 | 0.31 | 0.36 | 0.22 | 0.36 | 1.36 | 0.15 | 0.54 | 0.05 |
| Phosphorylcholine | C00588 | −0.27 | −0.42 | −0.32 | 0.22 | 1.33 | 0.14 | 0.58 | 0.06 |
| homocysteic acid | C16511 | −0.41 | −0.38 | −0.18 | 0.01 | 1.39 | 0.07 | 1.40 | 0.06 |
| Pyrophosphate | C00013 | 0.26 | 0.06 | −0.12 | 0.26 | 1.59 | 0.27 | 0.31 | 0.06 |
| deoxyuridine | C00526 | −0.20 | −0.36 | −0.30 | −0.02 | 0.87 | 0.29 | 1.22 | 0.06 |
| proline | C00148 | −0.03 | −0.13 | −0.14 | 0.59 | 2.83 | 0.00 | 0.60 | 0.07 |
| dimethylglycine | C01026 | 0.26 | 0.34 | 0.24 | 0.21 | 1.06 | 0.73 | 0.67 | 0.08 |
| Xanthurenic acid | C02470 | 0.35 | 0.44 | 0.29 | 0.33 | 1.24 | 0.25 | 0.61 | 0.08 |
| glutamate | C00025 | −0.10 | −0.11 | −0.06 | 0.45 | 0.62 | 0.12 | 0.25 | 0.08 |
| Methylmalonic | C02170 | 0.36 | 0.41 | 0.24 | 0.10 | 1.47 | 0.29 | 0.35 | 0.09 |
| acid | | | | | | | | | |
| deoxyadenosine | C00559 | 0.02 | 0.20 | 0.23 | 0.32 | 1.23 | 0.17 | 0.68 | 0.09 |
| succinate | C00042 | 0.38 | 0.38 | 0.20 | 0.12 | 1.49 | 0.27 | 0.36 | 0.09 |
| ethanolamine | C00189 | −0.33 | −0.27 | −0.09 | −0.22 | 1.13 | 0.33 | 1.31 | 0.10 |
| taurine | C00245 | −0.01 | 0.16 | 0.21 | 0.58 | 1.50 | 0.01 | 0.72 | 0.10 |
| serine | C00065 | −0.10 | 0.13 | 0.23 | 0.45 | 1.58 | 0.05 | 0.62 | 0.11 |
| lactate | C00186 | 0.24 | 0.40 | 0.32 | 0.31 | 1.34 | 0.06 | 0.72 | 0.12 |
| Cystine | C00491 | 0.25 | 0.43 | 0.35 | 0.29 | 1.98 | 0.06 | 0.50 | 0.13 |
| aconitate | C00417 | 0.11 | 0.21 | 0.18 | 0.32 | 0.84 | 0.11 | 0.78 | 0.13 |
| Creatinine | C00791 | 0.00 | 0.36 | 0.45 | −0.20 | 0.99 | 0.12 | 1.02 | 0.14 |
| S-adenosyl-L- | C00021 | −0.20 | −0.45 | −0.41 | −0.13 | 1.15 | 0.33 | 1.30 | 0.15 |
| homocysteine-nega | | | | | | | | | |
| 6-phospho-D- | C00345 | 0.19 | 0.48 | 0.47 | 0.47 | 1.04 | 0.29 | 0.95 | 0.16 |
| gluconate | | | | | | | | | |
| acadesine | D02742 | 0.05 | 0.17 | 0.18 | 0.42 | 1.29 | 0.36 | 0.52 | 0.16 |
| methylnicotinamide | C02918 | 0.01 | 0.22 | 0.27 | −0.03 | 1.25 | 0.39 | 0.70 | 0.18 |
| Pyroglutamic acid | C01879 | −0.04 | −0.21 | −0.24 | 0.25 | 0.68 | 0.14 | 0.51 | 0.19 |
| adenine | C00147 | −0.23 | −0.27 | −0.17 | 0.36 | 0.49 | 0.03 | 0.43 | 0.19 |
| Kynurenic acid | C01717 | −0.62 | −0.13 | 0.29 | −0.12 | 0.91 | 0.55 | 1.43 | 0.19 |
| cytidine | C00475 | −0.57 | −0.62 | −0.36 | −0.02 | 0.69 | 0.15 | 1.61 | 0.19 |
| malate | C00149 | 0.14 | 0.42 | 0.41 | 0.22 | 4.43 | 0.22 | 0.10 | 0.19 |
| glutamine | C00064 | −0.02 | −0.04 | −0.04 | 0.41 | 1.36 | 0.05 | 0.76 | 0.19 |
| 2-keto-isovalerate | C00141 | 0.14 | 0.41 | 0.41 | 0.24 | 3.42 | 0.20 | 0.18 | 0.20 |
| Maleic acid | C01384 | 0.13 | 0.41 | 0.42 | 0.25 | 3.41 | 0.21 | 0.18 | 0.20 |
| fumarate | C00122 | 0.13 | 0.41 | 0.41 | 0.26 | 3.35 | 0.21 | 0.19 | 0.21 |
| trehalose-sucrose | C00089 | −0.24 | −0.35 | −0.26 | 0.15 | 2.00 | 0.13 | 0.47 | 0.21 |
| nicotinamide | C00153 | −0.55 | −0.05 | 0.34 | 0.38 | 0.34 | 0.03 | 1.79 | 0.22 |
| sn-glycerol-3- | C00093 | −0.07 | −0.13 | −0.10 | −0.07 | 0.80 | 0.07 | 0.82 | 0.23 |
| phosphate | | | | | | | | | |
| DL-Pipecolic acid | C00408 | −0.16 | −0.28 | −0.23 | 0.23 | 0.82 | 0.48 | 0.55 | 0.23 |
| myo-inositol | C00137 | −0.69 | −0.72 | −0.40 | 0.16 | 0.65 | 0.02 | 1.31 | 0.24 |
| N6-Acetyl-L-lysine | C02727 | −0.03 | −0.19 | −0.21 | 0.59 | 1.46 | 0.01 | 0.84 | 0.24 |
| betaine | C00719 | 0.22 | 0.46 | 0.41 | −0.01 | 1.19 | 0.08 | 0.88 | 0.25 |
| lysine | C00047 | −0.03 | 0.03 | 0.06 | 0.53 | 1.54 | 0.03 | 0.74 | 0.26 |
| Phenylpropiolic | HMDB00563 | 0.72 | 0.57 | 0.18 | −0.13 | 1.26 | 0.00 | 0.91 | 0.26 |
| acid | | | | | | | | | |
| a-ketoglutarate | C00026 | 0.11 | 0.36 | 0.37 | 0.38 | 8.00 | 0.25 | 0.08 | 0.26 |
| uracil | C00106 | 0.25 | −0.05 | −0.24 | −0.17 | 0.93 | 0.64 | 1.32 | 0.26 |
| Carbamoyl | C00169 | −0.19 | 0.07 | 0.22 | 0.24 | 0.81 | 0.16 | 0.82 | 0.26 |
| phosphate | | | | | | | | | |
| 2-oxobutanoate | C00109 | 0.06 | 0.23 | 0.24 | 0.47 | 1.02 | 0.71 | 0.94 | 0.27 |
| p-aminobenzoate | C00568 | 0.32 | 0.28 | 0.11 | 0.18 | 1.24 | 0.25 | 0.78 | 0.27 |
| N-acetyl-L- | C00437 | −0.21 | −0.32 | −0.24 | 0.33 | 0.81 | 0.12 | 0.82 | 0.27 |
| ornithine | | | | | | | | | |
| phenylalanine | C00079 | 0.13 | 0.17 | 0.11 | 0.17 | 1.34 | 0.04 | 0.82 | 0.28 |
| purine | C00465 | 0.08 | 0.02 | −0.03 | 0.13 | 1.47 | 0.01 | 0.81 | 0.28 |
| N-acetyl-glutamine | HMDB06029 | 0.01 | −0.01 | −0.02 | 0.56 | 1.43 | 0.02 | 0.83 | 0.28 |
| 5-phosphoribosyl- | C00119 | 0.21 | 0.01 | −0.14 | −0.33 | 0.93 | 0.45 | 0.87 | 0.29 |
| 1-pyrophosphate | | | | | | | | | |
| carnitine | C00318 | −0.01 | 0.06 | 0.08 | 0.25 | 1.10 | 0.65 | 0.70 | 0.29 |
| S-methyl-5- | C00170 | −0.32 | −0.27 | −0.10 | 0.26 | 1.50 | 0.04 | 0.77 | 0.30 |
| thioadenosine | | | | | | | | | |
| xanthine | C00385 | 0.03 | 0.39 | 0.46 | 0.20 | 1.21 | 0.16 | 0.82 | 0.31 |
| 7-methylguanosine | HMDB01107 | 0.08 | 0.35 | 0.38 | 0.27 | 1.59 | 0.05 | 0.73 | 0.31 |
| methionine | C00073 | −0.17 | −0.21 | −0.14 | 0.25 | 2.27 | 0.01 | 0.70 | 0.31 |
| threonine | C00188 | −0.03 | −0.19 | −0.22 | 0.28 | 1.13 | 0.56 | 0.72 | 0.33 |
| Acetyllysine | C02727 | −0.15 | −0.12 | −0.04 | 0.63 | 1.45 | 0.01 | 0.85 | 0.33 |
| isocitrate | C00311 | −0.14 | −0.01 | 0.08 | −0.04 | 0.72 | 0.04 | 1.27 | 0.33 |
| 2-hydroxygluterate | C03196 | 0.08 | 0.32 | 0.34 | 0.45 | 0.54 | 0.17 | 0.31 | 0.33 |
| Kynurenine | C00328 | 0.15 | 0.27 | 0.23 | 0.43 | 1.60 | 0.23 | 0.60 | 0.34 |
| biotin | C00120 | −0.10 | −0.16 | −0.13 | 0.63 | 2.96 | 0.00 | 0.88 | 0.34 |
| ribose-phosphate | C00117 | 0.12 | 0.15 | 0.10 | 0.19 | 0.73 | 0.02 | 0.84 | 0.35 |
| pantothenate | C00864 | −0.09 | 0.19 | 0.31 | −0.67 | 0.51 | 0.13 | 1.34 | 0.35 |
| NG-NG-dimethyl- | C03626 | 0.31 | 0.37 | 0.23 | 0.34 | 0.49 | 0.08 | 0.80 | 0.36 |
| L-arginine | | | | | | | | | |
| uridine | C00299 | 0.22 | −0.09 | −0.27 | −0.13 | 0.89 | 0.49 | 1.26 | 0.37 |
| thiamine | C01081 | 0.26 | 0.41 | 0.32 | −0.28 | 7.99 | 0.04 | 0.53 | 0.37 |
| acetoacetate | C00164 | 0.57 | 0.60 | 0.34 | 0.06 | 1.06 | 0.29 | 0.92 | 0.37 |
| betaine aldehyde | C00576 | 0.09 | −0.22 | −0.33 | 0.22 | 0.96 | 0.76 | 0.85 | 0.37 |
| inosine | C00294 | −0.35 | −0.46 | −0.32 | −0.26 | 0.93 | 0.66 | 1.26 | 0.39 |
| N-acetyl-L-alanine | C01073 | 0.32 | 0.49 | 0.37 | 0.35 | 1.03 | 0.77 | 0.88 | 0.40 |
| ornithine | C00077 | −0.17 | −0.35 | −0.31 | 0.04 | 1.20 | 0.25 | 0.85 | 0.40 |
| D-glucarate | C00767 | 0.02 | 0.21 | 0.25 | 0.52 | 1.19 | 0.24 | 0.86 | 0.41 |
| Atrolactic acid | HMDB00475 | 0.03 | 0.10 | 0.11 | 0.53 | 1.66 | 0.01 | 0.83 | 0.41 |
| orotate | C00295 | −0.05 | −0.05 | −0.03 | 0.52 | 2.15 | 0.00 | 0.94 | 0.43 |
| Phenyllactic acid | C01479 | 0.01 | 0.14 | 0.16 | 0.40 | 1.56 | 0.00 | 0.90 | 0.43 |
| D-gluconate | C00257 | 0.43 | 0.00 | −0.31 | −0.03 | 1.13 | 0.53 | 0.84 | 0.43 |
| Guanidoacetic acid | C00581 | −0.15 | −0.17 | −0.10 | 0.08 | 1.11 | 0.32 | 1.15 | 0.45 |
| dihydroorotate | C00337 | −0.14 | −0.14 | −0.08 | 0.42 | 2.19 | 0.00 | 0.95 | 0.45 |
| glucono-d-lactone | C00198 | 0.18 | 0.35 | 0.30 | −0.10 | 2.14 | 0.00 | 1.09 | 0.47 |
| glucosamine | C00329 | −0.40 | −0.04 | 0.24 | −0.07 | 1.38 | 0.03 | 1.16 | 0.48 |
| glyoxylate | C00048 | −0.07 | −0.34 | −0.37 | 0.02 | 0.85 | 0.11 | 0.92 | 0.50 |
| Uric acid | C00366 | 0.21 | 0.50 | 0.47 | 0.43 | 1.60 | 0.07 | 0.82 | 0.51 |
| SBP | C00447 | −0.29 | 0.07 | 0.30 | 0.40 | 1.17 | 0.24 | 0.89 | 0.52 |
| 2-Hydroxy-2- | C02612 | −0.02 | 0.45 | 0.56 | 0.40 | 0.22 | 0.00 | 0.82 | 0.53 |
| methylbutanedioic | | | | | | | | | |
| acid | | | | | | | | | |
| hydroxyphenylpyruvate | C01179 | 0.03 | 0.13 | 0.14 | −0.29 | 0.96 | 0.62 | 0.93 | 0.56 |
| Imidazoleacetic | C05828 | −0.40 | −0.53 | −0.37 | −0.20 | 1.02 | 0.72 | 0.95 | 0.56 |
| acid | | | | | | | | | |
| valine | C00183 | −0.01 | −0.06 | −0.07 | 0.05 | 1.20 | 0.34 | 0.91 | 0.58 |
| Octulose-1,8- | none | 0.34 | 0.46 | 0.32 | −0.30 | 1.54 | 0.08 | 1.05 | 0.59 |
| bisphosphate | | | | | | | | | |
| oxaloacetate | C00036 | 0.09 | −0.17 | −0.27 | 0.24 | 1.77 | 0.01 | 0.87 | 0.61 |
| xanthosine | C01762 | 0.11 | 0.08 | 0.02 | 0.56 | 1.07 | 0.63 | 0.91 | 0.61 |
| N-acetyl-glutamate | C00624 | −0.41 | −0.28 | −0.05 | −0.12 | 0.85 | 0.32 | 0.92 | 0.65 |
| Acetylcarnitine DL | C02571 | 0.54 | 0.67 | 0.44 | 0.09 | 5.23 | 0.00 | 0.90 | 0.68 |
| Indole-3-carboxylic | HMDB03320 | −0.09 | −0.30 | −0.31 | 0.38 | 1.88 | 0.00 | 1.05 | 0.68 |
| acid | | | | | | | | | |
| allantoin | C01551 | 0.41 | 0.47 | 0.28 | 0.51 | 1.14 | 0.64 | 0.89 | 0.68 |
| citrate | C00158 | 0.23 | −0.01 | −0.18 | −0.13 | 0.97 | 0.75 | 1.05 | 0.71 |
| 2,3- | C00196 | −0.06 | −0.01 | 0.03 | 0.63 | 2.13 | 0.00 | 0.97 | 0.71 |
| dihydroxybenzoic | | | | | | | | | |
| acid | | | | | | | | | |
| 2-ketohaxanoic | HMDB01864 | −0.02 | 0.38 | 0.48 | 0.30 | 3.16 | 0.02 | 0.85 | 0.71 |
| acid | | | | | | | | | |
| shikimate | C04236 | 0.28 | 0.17 | 0.00 | 0.22 | 3.69 | 0.01 | 0.83 | 0.72 |
| L-arginino- | C03406 | −0.09 | −0.39 | −0.42 | −0.22 | 0.98 | 0.91 | 1.08 | 0.73 |
| succinate | | | | | | | | | |
| 4-Pyridoxic acid | C00847 | 0.10 | 0.48 | 0.52 | 0.11 | 0.71 | 0.45 | 0.89 | 0.75 |
| 1-Methyladenosine | C02494 | 0.15 | 0.51 | 0.52 | −0.03 | 1.43 | 0.06 | 0.92 | 0.75 |
| leucine-isoleucine | C00123 | −0.32 | −0.34 | −0.19 | 0.10 | 1.26 | 0.08 | 0.97 | 0.78 |
| dTMP | C00364 | −0.44 | −0.42 | −0.20 | −0.38 | 1.53 | 0.00 | 1.02 | 0.82 |
| cytosine | C00380 | −0.37 | −0.29 | −0.10 | 0.44 | 0.81 | 0.27 | 1.04 | 0.83 |
| 3- | HMDB02222 | −0.22 | −0.01 | 0.15 | −0.25 | 1.17 | 0.25 | 1.04 | 0.83 |
| methylphenylacetic | | | | | | | | | |
| acid | | | | | | | | | |
| glucose-1- | C00103 | 0.06 | 0.01 | −0.03 | −0.24 | 0.91 | 0.05 | 0.99 | 0.85 |
| phosphate | | | | | | | | | |
| Aminoadipic acid | C00956 | −0.15 | −0.50 | −0.51 | 0.48 | 1.90 | 0.00 | 1.02 | 0.86 |
| glycolate | C00160 | 0.13 | −0.11 | −0.22 | −0.28 | 0.86 | 0.13 | 1.03 | 0.86 |
| citrate-isocitrate | C00158 | 0.23 | −0.03 | −0.20 | −0.09 | 0.98 | 0.82 | 1.02 | 0.90 |
| Hydroxyisocaproic | HMDB00746 | −0.30 | −0.44 | −0.32 | 0.27 | 1.30 | 0.18 | 0.99 | 0.91 |
| acid | | | | | | | | | |
| Citraconic acid | C02226 | 0.38 | 0.07 | −0.18 | −0.16 | 1.04 | 0.70 | 0.98 | 0.92 |
| hypoxanthine | C00262 | −0.47 | −0.35 | −0.09 | −0.12 | 0.72 | 0.04 | 1.01 | 0.92 |
| N-acetyl- | C00140 | 0.12 | −0.31 | −0.47 | 0.08 | 1.20 | 0.10 | 0.99 | 0.92 |
| glucosamine | | | | | | | | | |
| hexose-phosphate | C00085 | −0.48 | −0.63 | −0.44 | 0.35 | 0.78 | 0.23 | 1.01 | 0.97 |
| acetylphosphate | C00227 | −0.43 | −0.42 | −0.21 | 0.21 | 1.44 | 0.16 | 1.00 | 0.99 |

### Metabolic Signatures Unique to Malignant Glioma CSF Samples

An analysis of the metabolite intensities and CVs revealed that gross differences exist in the small molecule composition of the CSF from these two patient-cohorts. Therefore, global differences in the small molecule composition were analyzed. One commonly used method to identify patterned, global differences in multivariate data sets involves using hierarchical clustering (Quackenbush, J., Nat. Rev. Genet. 2, 418-427 (2001); Sorlie, T., et al., Proc. Natl. Acad. Sci. U.S.A. 98, 10869-10874 (2001); and Sorlie, T., Proc. Natl. Acad. Sci. U.S.A. 100, 8418-8423 (2003)). Such clustering methods have been employed to study the organization of mRNA profiles in different samples in microarray collections of primary tumors (Collisson, E. A., et al., Nat. Med. 17, 500-503 (2011)). These methods are becoming increasingly appreciated in the oncology clinic for diagnosis and prognosis (Zhu, C. Q., et al., J. Clin. Oncol. 28, 4417-4424 (2010)).

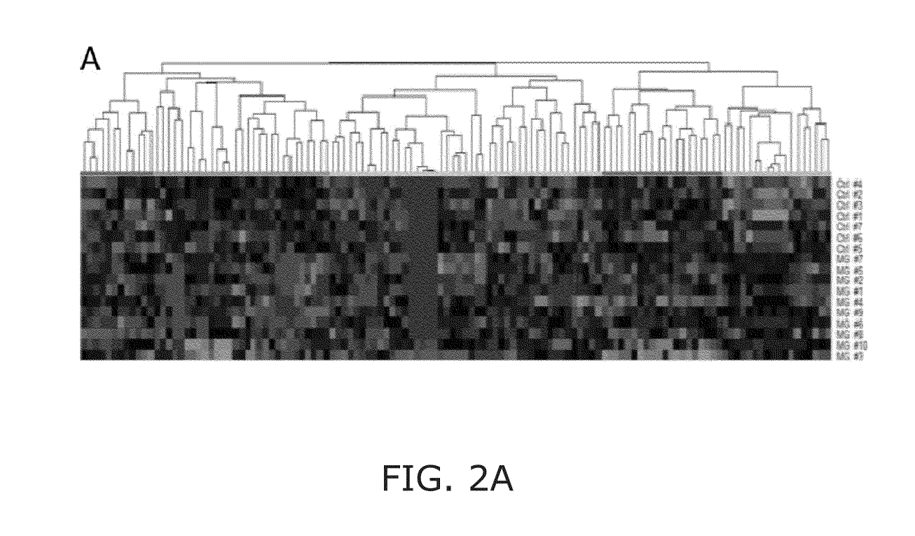

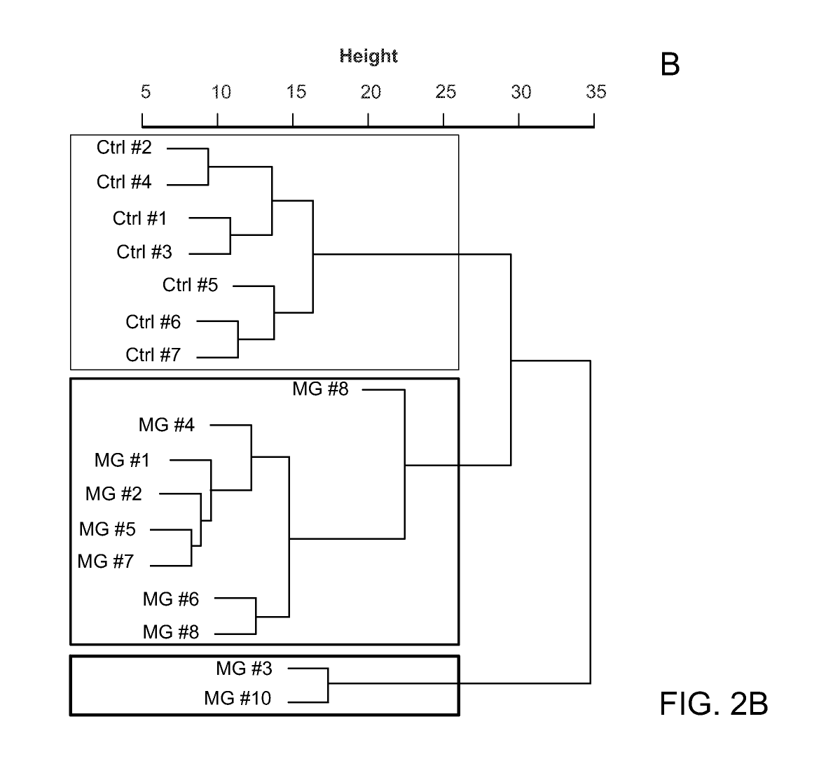

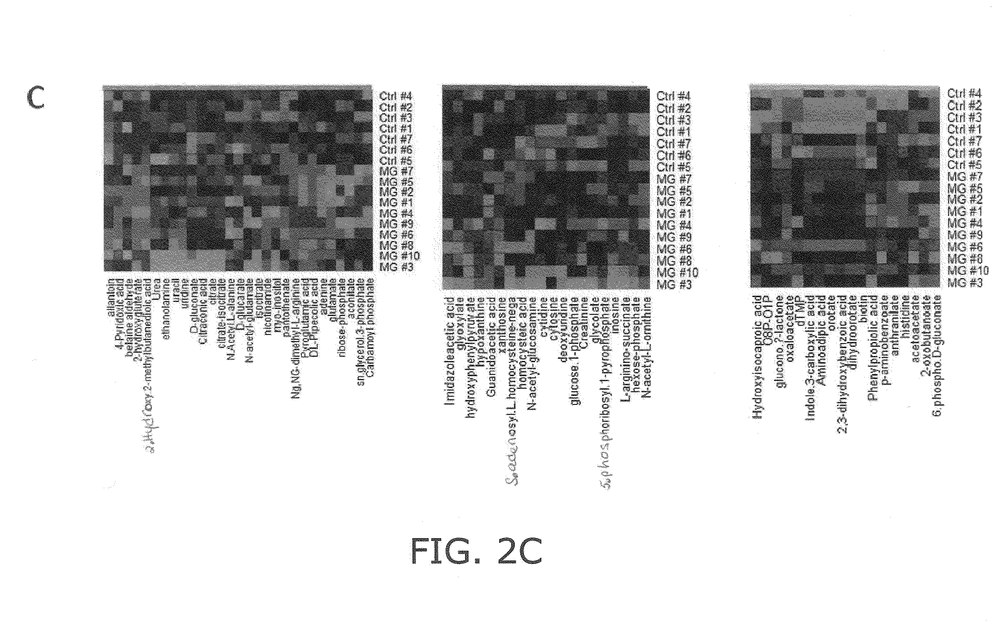

An unsupervised hierarchical clustering algorithm using Ward's method (Ward, J. H. J. Am. Stat. Assoc. 58, 236 (1963)). that minimizes the variance within clusters was carried out. Analysis of the resulting classification revealed distinct patterns of metabolites both enhanced and decreased in malignant glioma CSF samples relative to the control samples (FIG. 2A). The tree structure (FIG. 2B) revealed three separate branches corresponding to two classes of cancer patients and one additional branch corresponding to the control samples. The CSF samples from patients that have newly diagnosed malignant gliomas (Table I) (Patients 1, 2, 5, and 7) form a single cluster that is separated in distance from the other samples. FIG. 2C shows metabolite signatures that contribute to the clusters distinguishing MG from control subjects. Therefore, with no a priori information, this hierarchical classification not only segregated malignant glioma samples from controls, but also patients who have recurrent disease from those with newly diagnosed malignant gliomas (FIGS. 2A, B). Importantly, these changes cannot be distinguished from MRI measurements because there was no correlation between cluster group and MRI measurements.

To gain additional insights into the ability to classify malignant glioma patients based on the metabolic composition of CSF, additional unsupervised learning methods were examined. Although overall, different classification methods should give consistent results, different methods may reveal different details about the fine structure of the data. Thus, a principal components analysis (PCA) was also carried out. Using PCA, correlations in the metabolite levels are computed and the matrix of these correlations is rotated into directions (eigenvectors) that account for the largest sample variance (Ringner, M. Nat. Biotechnol. 26, 303-304 (2008)). An analysis of these directions provides an unbiased means of clustering the samples by accounting for the relative contribution of each direction to each sample. Metabolites that comprise the coefficients of these eigenvectors can give a biological interpretation to the computation by identifying groups of metabolites that covary.

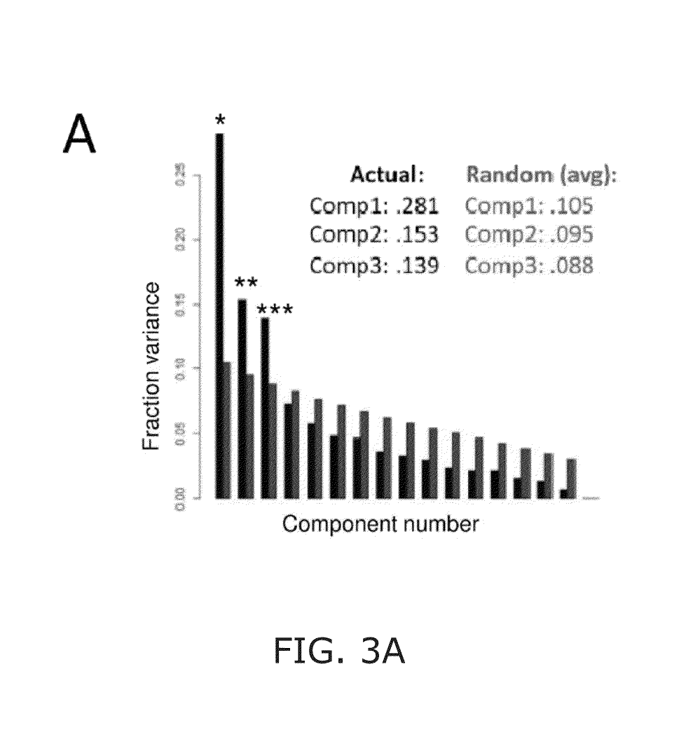

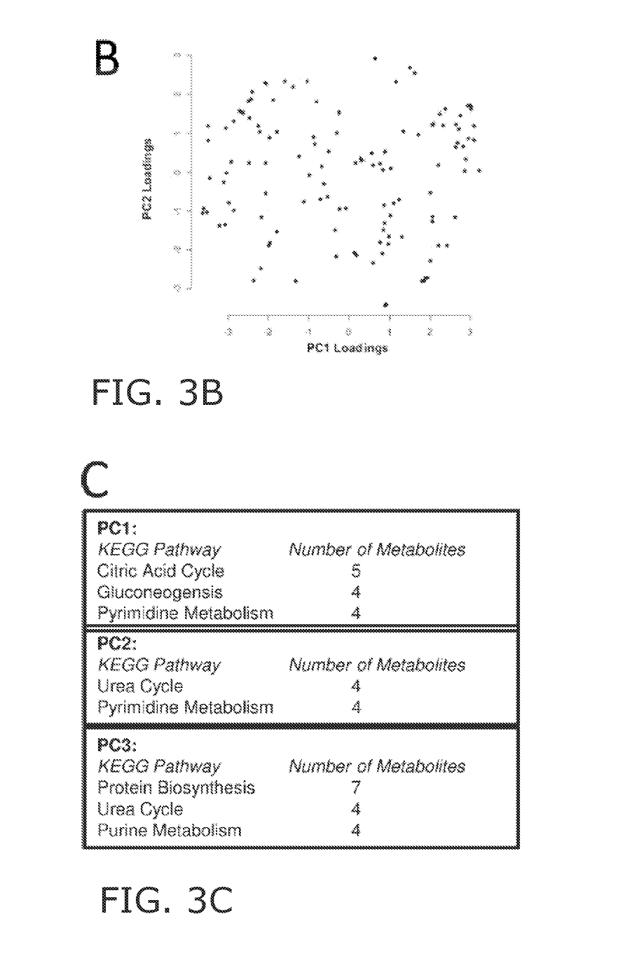

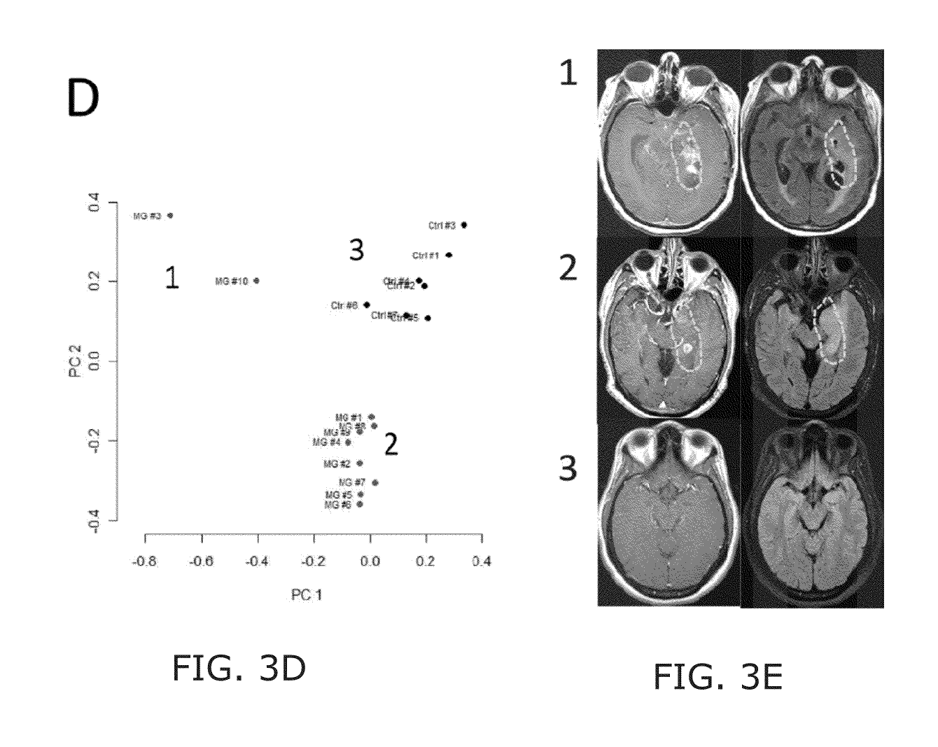

The statistical significance of a PCA analysis on the raw data was first assessed. A Monte Carlo algorithm (methods) was used to compute a distribution of eigenvalues obtained from random data of equal mean and variance to that of the measured data. A one-tailed p value for each eigenvalue was obtained from this distribution. It was found that the first, second, and third components were highly statistically significant (*, p=8.3×10⁻¹⁵; **, p=2.6×10⁻⁵; and ***, p=1.8×10⁻⁹ respectively). Components one, two, and three captured 28.1%, 15.3%, and 13.9% percent of the variance respectively (FIG. 3A).

A loadings plot which contains coefficients of the first two eigenvectors is shown in FIG. 3B. From inspection of FIG. 3B, it is apparent that there is overlap in the largest contributing coefficients but some metabolite contributions are unique to each component. To further interpret the components, the KEGG database was used to interpret the coefficients by overlaying the top 40 coefficients onto the KEGG metabolic pathway map (FIG. 3C). From an analysis of the pathways involved in each principal component, it is apparent that metabolites from pyrimidine metabolism contribute to both components (FIG. 3C). Metabolites from the citric acid cycle (n=5), gluconeogenesis (n=4), and pyrimidine metabolism (n=4) appear in the first component. Metabolites from the urea cycle (n=4) and pyrimidine metabolism (n=4) emerge in the second component. The third component comprises metabolites from protein biosynthesis (n=7), the urea cycle (n=4), and purine metabolism. Together, these findings suggest that distinct, interpretable biological process are defining the glioma samples and accounting for its separation from control samples.

A scatter plot (scores plot) of the projections of each sample onto the first two principal components is shown in FIG. 3D. From the scatter plot, it is apparent that two subsets of malignant glioma patients were identified and they are distinguished from the control samples. When a k-means clustering was overlaid onto each sample by denoting each cluster with a different color (FIG. 3D), a similar pattern is observed. Thus, while both the hierarchical clustering and PCA give similar overall results, each method identified different details within the data.

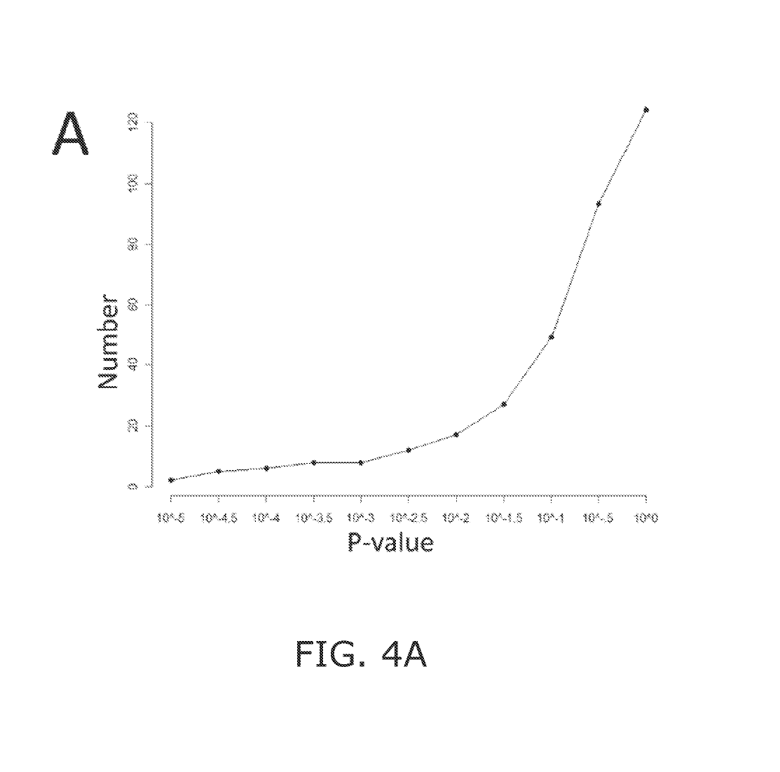

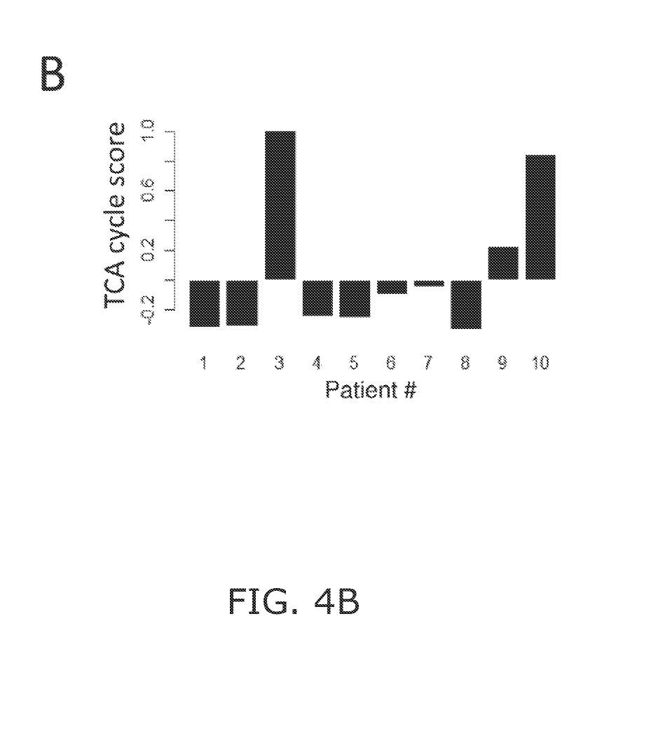

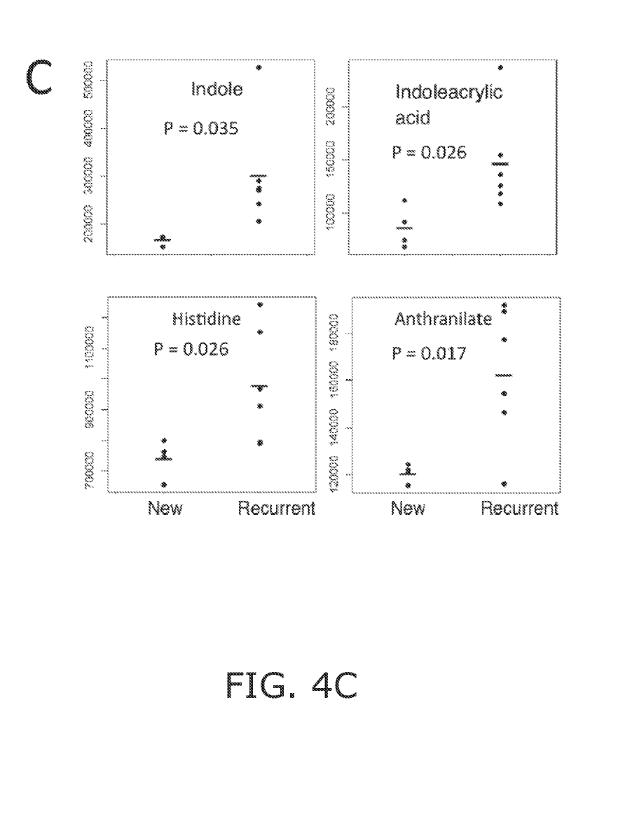

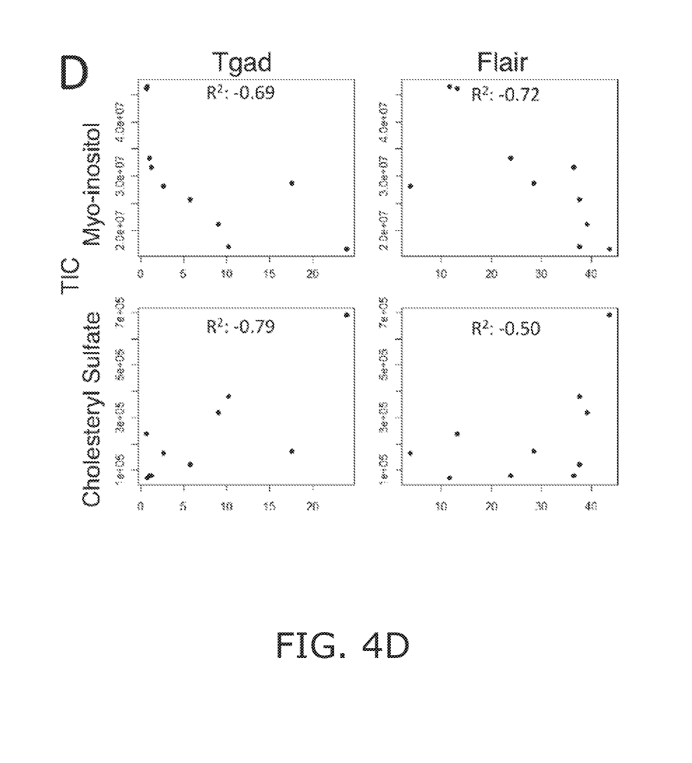

The metabolites that differ overall from controls to glioma patients was next considered. Although the classification algorithms were able to define finer structure in the data which points to the existence of subtypes, these subtypes (with the exception of the separation of recurrent and newly diagnosed) are not yet defined clinically. Therefore, an overall comparison since such an analysis could have the most immediate clinical application for diagnostic biomarker discovery was chosen. Thirty-nine metabolites significantly changed in the CSF of the malignant gliomas relative to the control samples using a more stringent two-tailed t test statistic (p<0.05) (FIG. 4A, Table II). These metabolites originate from several metabolic pathways such as amino acid, lipid, pyrimidine, and central carbon metabolism. One recently identified metabolite biomarker in glioma patients is 2-hydroxyglutarate (2-HG). Interestingly, the level of 2-HG is also several folds higher in patient 3 which could indicate the presence of an IDH1 mutation in the tumor (Dang, L., et al., Nature 462, 739-744 (2009)).

The different subtypes of metabolic profiles observed in the CSF of malignant glioma patients included a group characterized by new diagnosis (Patients 1, 2, 5, and 7) and a set of two patients (Patients 3 and 10) with recurrent disease that exhibit a similar profile but have distinct profiles from the other CSF samples (FIG. 3B). An inspection of the signature of metabolites that delineates patients 3 and 10 revealed a specific enrichment in metabolites derived from the citric acid (TCA) cycle (FIG. 4B). This increase in TCA cycle metabolites was not observed in other patients suggesting that this signature may identify a subset of malignant glioma patients at disease recurrence.

An inspection of metabolites specific to newly-diagnosed patients revealed seven metabolites that change (p<0.05) in this subset relative to the patients with recurrent disease (FIG. 4C). Interestingly, many of these metabolites are involved in tryptophan and histidine metabolism. These metabolites include indoleacrylic acid (p=0.026), indole (p=0.035), histidine (p=0.03), and anthranilate (p=0.017). An enzyme in this pathway indolamine 2,3 dioxygenase is commonly used as a biomarker for immune activity (Munn, D. H., et al., Science 281, 1191-1193 (1998)). Aberrant activity of this enzyme is also causally implicated in immune-mediated neurological disorders (Dantzer, R., Nat. Rev. Neurosci. 9, 46-56 (2008)). It is thus likely the alterations in the concentrations of these metabolites are indicative of immune activity in these patients.

TABLE II
Metabolite changes in malignant glioma vs. control patients

| | | Fold Change (Malignant | |
|---|---|---|---|
| Metabolite | ID | glioma vs. control) | p value |
| biotin | C00120 | 2.96 | 1.03E−06 |
| glucono.d-lactone | C00198 | 2.14 | 6.57E−06 |
| dihydroorotate | C00337 | 2.19 | 1.65E−05 |
| orotate | C00295 | 2.15 | 1.80E−05 |
| 2.3-dihydroxybenzoic acid | C00196 | 2.13 | 2.96E−05 |
| Indole.3-carboxylic acid | HMDB03320 | 1.88 | 7.93E−05 |
| Acetylcarnitine DL | C02571 | 5.23 | 1.30E−04 |
| Aminoadipic acid | C00956 | 1.90 | 1.82E−04 |
| proline | C00148 | 2.83 | 1.23E−03 |
| Phenyllactic acid | C01479 | 1.56 | 1.30E−03 |
| 2.Hydroxy.2-methylbutanedioic acid | C02612 | 0.22 | 1.59E−03 |
| Phenylpropiolic acid | HMDB00563 | 1.26 | 1.78E−03 |
| dTMP | C00364 | 1.53 | 4.93E−03 |
| N6-Acetyl-l-lysine | C02727 | 1.46 | 5.27E−03 |
| oxaloacetate | C00036 | 1.77 | 6.80E−03 |
| Acetyllysine | C02727 | 1.45 | 8.51E−03 |
| shikimate | C04236 | 3.69 | 8.61E−03 |
| Atrolactic acid | HMDB00475 | 1.66 | 1.26E−02 |
| methionine | C00073 | 2.27 | 1.27E−02 |
| taurine | C00245 | 1.50 | 1.29E−02 |
| purine | C00465 | 1.47 | 1.48E−02 |
| N-acetyl-glutamine | HMDB06029 | 1.43 | 1.80E−02 |
| 2-ketohaxanoic acid | HMDB01864 | 3.16 | 1.93E−02 |
| ribose-phosphate | C00117 | 0.73 | 2.15E−02 |
| myo-inositol | C00137 | 0.65 | 2.27E−02 |
| lysine | C00047 | 1.54 | 2.86E−02 |
| glucosamine | C00329 | 1.38 | 3.02E−02 |
| adenine | C00147 | 0.49 | 3.23E−02 |
| nicotinamide | C00153 | 0.34 | 3.40E−02 |
| thiamine | C01081 | 7.99 | 3.51E−02 |
| phenylalanine | C00079 | 1.34 | 3.53E−02 |
| S-methyl-5-thioadenosine | C00170 | 1.50 | 4.07E−02 |
| hypoxanthine | C00262 | 0.72 | 4.14E−02 |
| isocitrate | C00311 | 0.72 | 4.36E−02 |
| serine | C00065 | 1.58 | 4.74E−02 |
| 7-methylguanosine | HMDB01107 | 1.59 | 4.85E−02 |
| glutamine | C00064 | 1.36 | 4.85E−02 |
| glucose.1-phosphate | C00103 | 0.91 | 4.86E−02 |

Correlations with Clinical Parameters

Potential clinical applications of the metabolomics analysis require that the measurements be compared with known methods used in clinical settings. Because clinical parameters were available for the patients in this study, the relative levels of individual metabolites correlated with measures of tumor size was assessed. Two parameters that are used to estimate tumor size in glioma patients are MRI-based measurements of T₁ relaxation of gadolinium (Tgad) and the T₁ relaxation using fluid attenuation inversion recovery (FLAIR) (Lacroix, M., et al., J. Neurosurg. 95, 190-198 (2001)). Although higher-order, multivariate analyses such as partial least squares regression are important for describing complex responses, such analyses to give helpful results would require larger sample sizes. Therefore univariate correlations were considered.

These measurements of tumor-size with metabolites was correlated and it was found that eight metabolites correlated with Tgad and ten correlated with FLAIR (R²>0.50) (supplemental Table S1, FIG. 4D). Of these metabolites, the levels of six of these correlated with both measurements. The levels of four metabolites are correlated positively and two are negatively correlated with tumor size. These metabolites are myoinositol (Tgad R²=−0.69, FLAIR R²=−0.72), acetylcarnitine (Tgad R²=0.54, FLAIR R²=0.67), cytidine (Tgad R²=−0.56, FLAIR R²=−0.62), acetoacetate (Tgad R²=0.57, FLAIR R²=0.60), phenylpropiolic acid (Tgad R²=0.72, FLAIR R²=0.57), and cholesteryl sulfate (Tgad R²=0.79, FLAIR R²=0.50).

Another parameter of clinical interest is patient survival. Metabolites that correlate with patient survival were then assessed. Fourteen metabolites were found to correlate with patient survival (R²>0.50) (supplemental Table S1). Three of these metabolites (panthothenate, biotin, and taurine) are common dietary supplements suggesting that the consumption of these compounds can be detected in the CSF. The other metabolites involve intermediates in nucleotide and amino acid metabolism (Supplemental Table S1).

### Discussion

A global polar metabolome analysis of human CSF from a small cohort of patients with malignant gliomas is presented. In this study, it was tested and shown that statistically significant signatures of glioma and normal patients can be obtained from a small sample size. The study explored (1) an advanced positive and negative switching LC-MS/MS platform for the fragmentation and detection of metabolites, (2) unsupervised classification algorithms to detect aggregate differences of metabolites between patient samples, and (3) the inherent physiology of systemic cancer-associated metabolism. This approach achieved success for several reasons. The LC-MS/MS SRM based platform consists of a highly sensitive hybrid triple quadrupole MS and allows for chromatographic separation with selective and ultrafast detection with positive and negative switching. This is important because clinically relevant metabolites may exist transiently and in low-abundance due to inherent instability in biological fluids. Also, multiple classification algorithms were used, including hierarchical clustering and principle component analysis, which provides independent validation of signatures that distinguish malignant gliomas from control samples as well as patients with recurrent and newly diagnosed disease. Lastly, an additional explanation for the success of this approach might be that metabolites resulting from abnormal metabolic chemical reactions can accumulate in the CSF in an exponential fashion with respect to the noise. The signal-to-noise ratio of clinically relevant biomarkers from the metabolomics platform is different from that in genomics and proteomics where the rise of metabolites is exponential, while genetic and protein products give linear signals, with respect to the amount of abnormal tissue. Therefore, despite the small sample size in this cohort, the robust differences in certain metabolite levels suggests that there is a great potential for metabolite biomarker discovery in CSF and, when taken in aggregate, metabolite signatures may also have the potential to be used as diagnostic biomarkers.

Because diffusion rates are much higher for small molecules than for cells and proteins, the site of CSF collection, lumbar versus ventricular, is likely less relevant than the steady-state levels of other biological materials. Gerber et al. investigated CSF biomarkers for bacterial meningitis and found that lactate from either lumbar or ventricular source had good linear correlation (r=0.79, p<0.001) as opposed to leukocyte (r=0.39, p=0.02) or protein levels (r=0.42, p=0.006) (Gerber, J., et al., Neurology 51, 1710-1714 (1998)). Each of the patient samples tested in the study herein was taken from the lumbar thecal sac except for subject 3 whose CSF was collected from a ventricular drain. Therefore, the collection method is unlikely to confound the analysis of the metabolome in the CSF. However, a rigorous demonstration of whether or not the absolute level of a given metabolite would be different between lumbar and ventricular sites would require the simultaneous collection and subsequent metabolomic analysis of CSF from both sites and such a collection is ethically unsound in routine clinical care. Furthermore, the cluster dendrogram demonstrated that subjects 3 and 10 are different from the rest of the malignant cohort. Indeed, these two subjects have larger tumors and later stage disease.

There are a number of sources giving rise to the detected metabolites in the CSF, including the tumor, stroma, and inflammatory cells that have migrated into the tumor microenvironment. First, malignant gliomas have altered metabolism directly induced by somatic mutations such as MYC amplification, PTEN deletion or protein loss, EGFR amplification, and IDH1/IDH2 mutations. The metabolic enzymes therefore catalyze reactions that result in the accumulation of abnormal metabolites in the CSF even though the tumor volume is at most less than one-tenth of the total volume of the brain and spinal cord. For example, IDH1 mutant cells can secrete enough 2-hydroxyglutarate into the cell culture medium to achieve a two molar concentration within 24 h (Dang, L., et al., Nature 462, 739-744 (2009) and Bralten, L. B. C., et al., Ann. Neurol. 69, 455-463 (2011)). Indeed, high levels of 2-hydroxyglutarate in patient 3 was able to be detected suggesting that this individual may have an IDH1-mutated malignant glioma. It was found that the CSF myo-inositol levels decrease, whereas cholesteryl sulfate level increases linearly respect to tumor size as measured by Tgad and FLAIR according to the Macdonald's criteria. Myo-inositol is a cerebral osmolyte found to be significantly lowered in glioblastomas and anaplastic astrocytomas than in low-grade gliomas and normal brain tissue as detected by magnetic resonance spectroscopy (MRS) (Kallenberg, K., et al., Radiology 253, 805-812 (2009) and Castillo, M., et al., Am. J. Neuroradiol. 21, 1645-1649 (2000)). Consistent with the previous MRS findings that decreasing myo-inositol level was associated with increasing aggressiveness of the glioma phenotype, the data also showed that the tumor size in the cohort negatively correlated with myo-inositol levels in the CSF. In contrast, cholesteryl sulfate is an important component of the cell membrane and it is distributed into the extracellular fluid such as the plasma (Strott, C. A., and Higashi, Y., J. Lipid Res. 44, 1268-1278 (2003)). The CSF of the cohort had cholesteryl sulfate that positively correlated with the tumor size. Furthermore, accumulation of cholesteryl sulfate was seen in human bronchial epithelial cells undergoing squamous metaplasia and this observation suggests that this metabolite may arise from the oncogenic transformation of normal tissue (Rearick, J. I., et al., Cancer Res. 48, 5289-5295 (1988)). Lastly, tryptophan metabolism is important for the activation and suppression of inflammation (Munn, D. H., et al., Science 281, 1191-1193 (1998); Dantzer, R., et al., Nat. Rev. Neurosci. 9, 46-56 (2008); Romani, L., et al., Nature 451, 211-215 (2008); and Grivennikov, S. I., et al., Cell 140, 883-899 (2010)). In the cohort with recurrent malignant gliomas, significantly elevated indole, indoleacrylic acid, and anthranilic acid was found, which are metabolites involved in the tryptophan metabolism, as compared with newly diagnosed patients. In addition, histidine, an essential amino acid and a precursor for the proinflammatory histamine, was also found to be markedly elevated in the patients with recurrent disease. These inflammation-associated metabolites may be byproducts of the innate immune system.

The accumulation of CSF metabolites from the TCA cycle may indicate advanced disease. Patients 3 and 10 both had recurrent malignant gliomas, with CSF samples taken 34 and 12 months from initial diagnosis, and their tumor sizes were large as measured by gadolinium-enhanced T1 and FLAIR images on head MRI. MRI is insufficient to delineate the entire tumor due to the infiltrative nature of the malignant glioma because tumor size is estimated based on the amount of contrast leakage from tumor vasculature. Because there are glioma cells outside of the area of active tumor angiogenesis, gadolinium enhancement as shown on T1 MRI underestimates the extent of the tumor. In contrast, FLAIR signal abnormality overestimates tumor size because FLAIR hyperintensity not only represents infiltrative tumor but also cerebral edema and radiation changes in the brain (Wong, E. T., J. Neuro-Oncol. 77, 295-296 (2006)).

Together the study described herein provides the first demonstration of metabolite profiling in the CSF of malignant glioma patients. The findings conclude that mass spectrometry-based metabolomics methods offer a promising technology for the discovery of biomarkers of malignant glioma from sampling biological fluid. Several biologically interpretable candidate biomarkers from both individual metabolites as well as from collective metabolite signatures were obtained.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of identifying a patient in need of therapy to treat a malignant glioma comprising
(a) measuring a panel of polar metabolite levels in a biological sample taken from the patient, wherein the polar metabolites are measured using a liquid chromatography/tandem mass spectrometry based platform;
(b) determining the levels of two or more polar metabolites present in the patient sample, wherein the polar metabolites comprise the polar metabolites in Supplemental Table S1;
(c) comparing the levels of the polar metabolites present in the sample to control levels, wherein a difference in the levels of two or more polar metabolites present in the sample relative to the control levels is indicative of the patient having a malignant glioma; and
(d) implementing a therapy to treat the malignant glioma in the patient.

2. The method of claim 1, wherein the control levels comprise the levels of the metabolites present in a sample from a healthy subject without a malignant glioma.

3. The method of claim 2, wherein increased levels of the metabolites present in the sample relative to the control levels is indicative of the patient having a malignant glioma.

4. The method of claim 2, wherein the same levels of the metabolites present in the sample relative to the control levels is indicative of the patient not having a malignant glioma.

5. The method of claim 2, wherein reduced levels of the metabolites present in the sample relative to the control levels is indicative of the patient having a malignant glioma.

6. The method of claim 1, wherein the two or more metabolites comprise: biotin, glucono-d-lactone, dihydroorotate, orotate, 2,3-dihydroxybenzoic acid, Indol-3-carboxylic acid, Acetylcarnitine DL, Aminoadipic acid, proline, Phenyllactic acid, dTMP, oxaloacetate, Atrolactic acid, methionine, taurine, 2-ketohaxanoic acid, lysine, thiamine, S-methyl-5-thioadenosine, serine, 7-methylguanosine, glutamine, 2-hydroxy-2-methylbutanedioic acid, Phenylpropiolic acid, dTMP, N6-acetyl-L-lysine, Acetyllysine, N-acetyl-glutamine, purine, ribose-phosphate, myo-inositol, glucosamine, adenine, nicotinamide, phenylalanine, glucose-1-phosphate, hypoxanthine and shikimate.

7. The method of claim 1, wherein the biological sample is selected from cerebrospinal fluid, blood, serum, plasma, urine, tissue from a biopsy, and tissue from a surgical resection.

8. A method of identifying a patient in need of therapy to treat a recurrent malignant glioma comprising
(a) measuring a panel of polar metabolite levels in a biological sample taken from the patient, wherein the polar metabolites are measured using a liquid chromatography/tandem mass spectrometry based platform;
(b) determining the levels of two or more polar metabolites present in the patient sample, wherein the polar metabolites comprise the polar metabolites in Supplemental Table S1,
(c) comparing the levels of the polar metabolites present in the sample to control levels, wherein a difference in the levels of the two or more polar metabolites present in the sample relative to the control levels is indicative of the patient having a recurrent malignant glioma; and
(d) implementing a therapy to treat the recurrent malignant glioma in the patient.

9. The method of claim 8, wherein the control levels comprise the levels of the metabolites present in a sample from a healthy subject without a malignant glioma.

10. The method of claim 9, wherein increased levels of the metabolites present in the sample relative to the control levels is indicative of the patient having a malignant glioma.

11. The method of claim 9, wherein the same levels of the metabolites present in the sample relative to the control levels is indicative of the patient not having a malignant glioma.

12. The method of claim 9, wherein reduced levels of the metabolites present in the sample relative to the control levels is indicative of the patient having a malignant glioma.

13. The method of claim 8, wherein the two or more metabolites comprise: biotin, glucono-d-lactone, dihydroorotate, orotate, 2,3-dihydroxybenzoic acid, Indole-3-carboxylic acid, Acetylcarnitine DL, Aminoadipic acid, proline, Phenyllactic acid, dTMP, oxaloacetate, Atrolactic acid, methionine, taurine, 2-ketohaxanoic acid, lysine, thiamine, S-methyl-5-thioadenosine, serine, 7-methylguanosine, glutamine, 2-hydroxy-2-methylbutanedioic acid, Phenylpropiolic acid, dTMP, N6-acetyl-L-lysine, Acetyllysine, N-acetyl-glutamine, purine, ribose-phosphate, myo-inositol, glucosamine, adenine, nicotinamide, phenylalanine, glucose-1-phosphate, hypoxanthine and shikimate.

14. The method of claim 8, wherein the two or more metabolites comprise indole, indoleacrylic acid, histidine and anthranilate.

15. The method of claim 8, wherein the biological sample is selected from cerebrospinal fluid, blood, serum, plasma, urine and tissue from a biopsy, and tissue from a surgical resection.

16. A method of monitoring a patient's response to treatment of a malignant glioma comprising
(a) measuring a panel of polar metabolite levels in a biological sample taken from the patient, wherein the polar metabolites are measured using a liquid chromatography/tandem mass spectrometry based platform;
(b) determining the levels of two or more polar metabolites present in the patient sample, wherein the polar metabolites comprise the polar metabolites in Supplemental Table S1;
(c) comparing the levels of the metabolites present in the sample to control levels, wherein a difference in the levels of the two ore more polar metabolites present in the sample relative to the control levels is indicative of the patient not responding to the treatment of the malignant glioma; and
(d) implementing a therapy to treat the malignant glioma in the patient.

17. The method of claim 16, wherein the control levels comprise the levels of the metabolites present in a sample from a healthy subject without a malignant glioma.

18. The method of claim 17, wherein increased levels of the metabolites present in the sample relative to the control levels is indicative of the patient not responding to the treatment of the malignant glioma.

19. The method of claim 17, wherein the same levels of the metabolites present in the sample relative to the control levels is indicative of the patient responding to the treatment of the malignant glioma.

20. The method of claim 17, wherein reduced levels of the metabolites present in the sample relative to the control levels is indicative of the patient not responding to the treatment of the malignant glioma.

21. The method of claim 16, wherein the two or more metabolites comprise: biotin, glucono-d-lactone, dihydroorotate, orotate, 2,3-dihydroxybenzoic acid, Indole-3-carboxylic acid, Acetylcarnitine DL, Aminoadipic acid, proline, Phenyllactic acid, dTMP, oxaloacetate, Atrolactic acid, methionine, taurine, 2-ketohaxanoic acid, lysine, thiamine, S-methyl-5-thioadenosine, serine, 7-methylguanosine, glutamine, 2-hydroxy-2-methylbutanedioic acid, Phenylpropiolic acid, dTMP, N6-acetyl-L-lysine, Acetyllysine, N-acetyl-glutamine, purine, ribose-phosphate, myo-inositol, glucosamine, adenine, nicotinamide, phenylalanine, glucose-1-phosphate, hypoxanthine and shikimate.

22. The method of claim 16, wherein the biological sample is selected from cerebrospinal fluid, blood, serum, plasma, urine, and tissue from a biopsy, and tissue from a surgical resection.
